(19) United States
(12) Patent Application Publication
(10) Pub. No.: US 2026/0277212 A1
(43) Pub. Date: Sep. 17, 2026

(54) SYSTEMS AND METHODS FOR CONFIGURING A ROBOT TO SCAN FOR FEATURES WITHIN AN ENVIRONMENT

(71) Applicant: Brain Corporation, San Diego, CA (US)

(72) Inventors: Soysal Degirmenci, San Diego, CA (US); Brandon Beckwith, San Diego, CA (US); Joanne Li, San Diego, CA (US); Arun Joseph, San Diego, CA (US)

(73) Assignee: Brain Corporation, San Diego, CA (US)

(21) Appl. No.: 19/565,006

(22) Filed: Mar. 12, 2026

Related U.S. Application Data
(63) Continuation of application No. 18/387,193, filed on Nov. 6, 2023.
Application No. 18/387,193 is a continuation of application No. PCT/US22/30231, filed on May 20, 2022.
(60) Provisional application No. 63/191,719, filed on May 21, 2021.

(51) Int. Cl. G05D 1/00

(52) U.S. Cl. CPC G05D 1/2297; G05D 1/243; G05D 1/628; G05D 2111/50

(57) ABSTRACT

Systems and methods for configuring a robot to scan for features are disclosed herein. According to at least one non-limiting exemplary embodiment, a robot may be configured to scan for features within an environment by producing various computer-readable maps which may be annotated to facilitate organized and accurate feature scanning.

### PRIORITY

This application is a continuation of U.S. application Ser. No. 18/387,193, filed Nov. 6, 2023, which is a continuation of PCT/US22/30231, filed May 20, 2022, and claims priority to U.S. provisional patent application No. 63/191,719 filed May 21, 2021 under 35 U.S.C. § 119, the entire disclosures of each of which are incorporated herein by reference.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### Technological Field

The present application generally relates to robotics, and more specifically to systems and methods for configuring a robot to scan for features within an environment.

### SUMMARY

The foregoing needs are satisfied by the present disclosure, which provides for, inter alia, systems and methods for configuring a robot to scan for features within an environment.

Exemplary embodiments described herein have innovative features, no single one of which is indispensable or solely responsible for their desirable attributes. Without limiting the scope of the claims, some of the advantageous features will now be summarized. One skilled in the art would appreciate that as used herein, the term robot may generally refer to an autonomous vehicle or object that travels a route, executes a task, or otherwise moves automatically upon executing or processing computer-readable instructions.

According to at least one non-limiting exemplary embodiment, a robot is disclosed. The robot comprises at least one processor configured to execute computer-readable instructions from a non-transitory computer-readable memory; the instructions, when executed, cause the at least one processor to: produce a site map; learn at least one local scanning route, each of the at least one local scanning routes corresponds to a local scanning route map; align the at least one local scanning route to the site map; receive annotations of the site map; and execute any of the at least one local scanning routes while scanning for features within sensor data from sensor units.

According to at least one non-limiting exemplary embodiment, the non-transitory computer-readable memory further comprises computer-readable instructions which configure the at least one processor to edit at least a portion of the at least one local scanning routes based on a user input to a user interface coupled to the robot.

According to at least one non-limiting exemplary embodiment, the non-transitory computer-readable memory further comprises computer-readable instructions which configure the at least one processor to transfer the annotations of the site map to each of the at least one local scanning route maps based on the alignment.

According to at least one non-limiting exemplary embodiment, the annotations comprise labels for scannable objects, the scannable objects being identified on the site map based on a user input; and the annotations comprise at least one scanning segment associated with each of the scannable objects, and the scanning segment defines a portion of a local scanning route or area within the environment wherein the robot collects sensor data to scan for features therein.

According to at least one non-limiting exemplary embodiment, the non-transitory computer-readable memory further comprises instructions which configure the at least one processor to store the sensor data collected proximate to a scanning segment into a file, directory, or bin in memory, the file, directory or bin being associated with an annotation corresponding to the object scanned; and store identified features in the corresponding bin, file, or directory in memory.

According to at least one non-limiting exemplary embodiment, the non-transitory computer-readable memory further comprises instructions which configure the at least one processor to: communicate the sensor data to a server communicatively coupled to the robot, the server being configured to identify features within the sensor data.

According to at least one non-limiting exemplary embodiment, the sensor data comprises one of images, LiDAR scans, depth imagery, or thermal data.

According to at least one non-limiting exemplary embodiment, each of the at least one local scanning route maps comprise at least one object localized at least in part thereon, the at least one object is also localized, at least in part, on the site map; and the alignment is performed by aligning the object on the at least one local scanning route to its location on the site map.

According to at least one non-limiting exemplary embodiment, a robot is disclosed. The robot comprises at least one processor configured to execute computer-readable instructions from a non-transitory computer-readable memory, the instructions, when executed, cause the at least one processor to: produce a site map while operating under user-guided control; learn at least one local scanning route while operating under user-guided control, wherein each of the at least one local scanning routes corresponds to a local scanning route map, each local scanning route map comprises at least a portion of an object which is also localized on the site map; edit at least a portion of the at least one local scanning routes based on a user input to a user interface coupled to the robot; align the at least one local scanning route to the site map by aligning, for each local scanning route map, the at least one portion of the object of the local scanning route map to its location on the site map; receive annotations of the site map, the annotations corresponding to labels for objects to be scanned for features and comprise (i) identification of an object to be scanned and (ii) at least one scanning segment associated with each of the scannable objects, the scanning segment defines a portion of a local scanning route or area within the environment wherein the robot collects sensor data to scan for features therein; transfer annotations of the site map to each of the at least one local scanning route maps based on the alignment; and execute any of the at least one local scanning routes while scanning for features within sensor data from sensor units; storing the sensor data collected proximate to a scanning segment into a file, directory, or bin in memory, the file, directory or bin being associated with an annotation corresponding to the object scanned; and store identified features in the corresponding bin, file, or directory in memory; wherein, the sensor data comprises images.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a,” “an,” and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a robot in accordance with some embodiments of this disclosure.

FIG. 1B is a functional block diagram of a controller or processor in accordance with some embodiments of this disclosure.

FIG. 2 illustrates a server communicatively coupled to a plurality of robots and devices, in accordance with some embodiments of this disclosure.

FIG. 3 illustrates a neural network, according to an exemplary embodiment.

FIG. 4 is a process flow diagram illustrating a method for a controller of a robot to configure the robot to scan for features within its environment, according to an exemplary embodiment.

FIG. 5A is a top-down reference view of an environment in accordance with some embodiments of this disclosure.

FIGS. 5B-C illustrate a robot producing a site map, according to an exemplary embodiment.

FIG. 6A illustrates one or more robots learning a plurality of local scanning routes, according to an exemplary embodiment.

FIG. 6B illustrates computer-readable maps produced during the training of the plurality of local scanning routes shown in FIG. 6A, according to an exemplary embodiment.

FIGS. 7A-B illustrate a process of a controller of a robot aligning a local scanning route map to a site map, according to an exemplary embodiment.

FIG. 8A illustrates annotations provided to a site map, according to an exemplary embodiment.

FIG. 8B illustrates bin-level annotations provided to scannable objects, according to an exemplary embodiment.

FIGS. 9A(i-ii)-9B illustrate various route edits performed on local scanning routes, according to an exemplary embodiment.

FIG. 10 is a top-down view of a robot scanning for features within its environment, according to an exemplary embodiment.

All Figures disclosed herein are@ Copyright 2022 Brain Corporation. All rights reserved.

### DETAILED DESCRIPTION

Currently, many robots operate within complex environments comprising a multitude of features. These features may comprise, for example, traffic flow of cars/humans, products in a retail store, objects in a warehouse, and similar things.

Currently, feature-tracking robots are utilized by retailers, warehouses, and other applications to provide useful insights on their operations. For example, robots may be used to track the traffic flow of humans within a store, airport, or on the road in cars to optimize the environment to avoid congestion. As another example, retailers often lose potential sales due to missing items, wherein a missing item may go unnoticed until (i) a customer alerts an associate, or (ii) the associate notices the missing item. In either case, there may be a substantial amount of time between an item going missing and being noticed and replaced. A missing item may comprise an out-of-stock item or an item which is in stock, but the shelf/display/sales floor is empty of the item, or a misplaced item. Sales lost due to missing items for retailers have been found to be on the order of $100 billion to $1 trillion worldwide and about $100 billion in North America alone. Accordingly, it is advantageous to utilize autonomous mobile robots to scan for features such that missing items, along with misplaced items and other features, may be readily and automatically identified by robots. The systems and methods disclosed herein enable a robot to be configured to scan for features within a new environment.

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such as an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

The present disclosure provides for systems and methods for configuring a robot to scan for features within an environment. As used herein, a robot may include mechanical and/or virtual entities configured to carry out a complex series of tasks or actions autonomously. In some exemplary embodiments, robots may be machines that are guided and/or instructed by computer programs and/or electronic circuitry. In some exemplary embodiments, robots may include electro-mechanical components that are configured for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, SEGWAY® vehicles, scooters, etc.), trailer movers, vehicles, and the like. Robots may also include any autonomous and/or semi-autonomous machines for transporting items, people, animals, cargo, freight, objects, luggage, and/or anything desirable from one location to another.

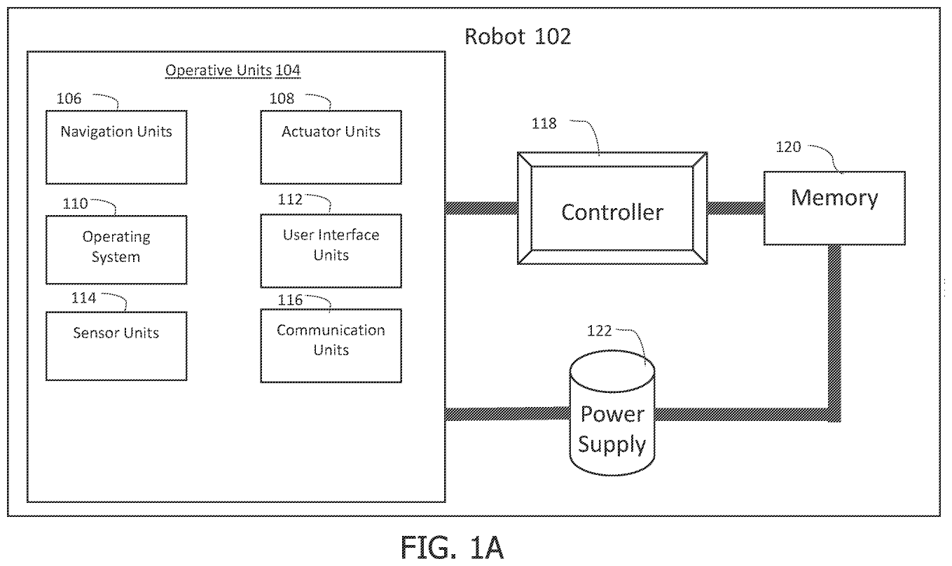

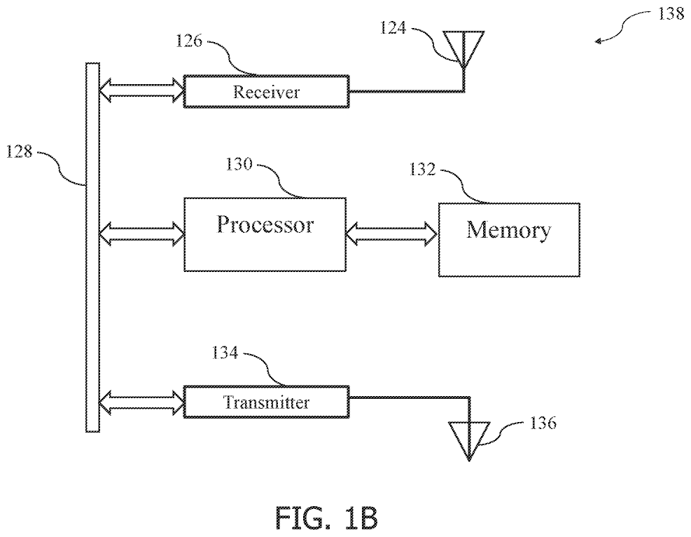

As used herein, a feature may comprise one or more numeric values (e.g., floating point, decimal, a tensor of values, etc.) characterizing an input from a sensor unit of a robot, described in FIG. 1A below, including, but not limited to, detection of an object, parameters of the object (e.g., size, shape, color, orientation, edges, etc.), the object itself, color values of pixels of an image, depth values of pixels of a depth image, brightness of an image, the image as a whole, changes of features over time (e.g., velocity, trajectory, etc. of an object), sounds, spectral energy of a spectrum bandwidth, motor feedback (i.e., encoder values), sensor values (e.g., gyroscope, accelerometer, GPS, magnetometer, etc. readings), a binary categorical variable, an enumerated type, a character/string, or any other characteristic of a sensory input. Features may be abstracted to many levels. For example, a box of cereal may be a feature of a shelf, the shelf may be a feature of a store, and the store may be a feature of a city. One skilled in the art may appreciate that, although certain portions of this disclosure utilize retail products as exemplary features, features are not intended to be limited to retail products and may include, for example, humans, paintings, and/or other things.

A training feature, as used herein, may comprise any feature for which a neural network is to be trained to identify or has been trained to identify within sensor data.

As used herein, a training pair, training set, or training input/output pair may comprise any pair of input data and output data used to train a neural network. Training pairs may comprise, for example, a red-green-blue (RGB) image and labels for the RGB image. Labels, as used herein, may comprise classifications or annotation of a pixel, region, or point of an image, point cloud, or other sensor data types, the classification corresponding to a feature that the pixel, region, or point represents (e.g., ‘car,’ ‘human,’ ‘cat,’ ‘soda,’ etc.). Labels may further comprise identification of a time-dependent parameter or trend including metadata associated with the parameter, such as, for example, temperature fluctuations labeled as ‘temperature’ with additional labels corresponding to a time when the temperature was measured (e.g., 3:00 μm, 4:00 μm, etc.), wherein labels of a time-dependent parameter or trend may be utilized to train a neural network to predict future values of the parameter or trend. As used herein, a model may represent any mathematical function relating an input to an output. Models may include a set of weights of nodes of a neural network, wherein the weights configure a mathematical function which relates an input at input nodes of the neural network to an output at output nodes of the neural network. Training a model is substantially similar to training a neural network because the model may be derived from the training of the neural network, wherein training of a model and training of a neural network, from which the model is derived, may be used interchangeably herein.

As used herein, scanning for features comprises identifying features within sensor data collected by sensor units of a robot.

As used herein, network interfaces may include any signal, data, or software interface with a component, network, or process including, without limitation, those of the FireWire (e.g., FW400, FW800, FWS800T, FWS1600, FWS3200, etc.), universal serial bus (“USB”) (e.g., USB 1.X, USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (802.11), WiMAX (e.g., WiMAX (802.16)), PAN (e.g., PAN/802.15), cellular (e.g., 3G, 4G, or 5G including LTE/LTE-A/TD-LTE/TD-LTE, GSM, etc. variants thereof), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, processor, microprocessor, and/or digital processor may include any type of digital processing device such as, without limitation, digital signal processors (“DSPs”), reduced instruction set computers (“RISC”), complex instruction set computers (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, and application-specific integrated circuits (“ASICs”). Such digital processors may be contained on a single unitary integrated circuit die or distributed across multiple components.

As used herein, computer program and/or software may include any sequence or human- or machine-cognizable steps which perform a function. Such computer program and/or software may be rendered in any programming language or environment including, for example, CIC++, C#, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

Detailed descriptions of the various embodiments of the system and methods of the disclosure are now provided. While many examples discussed herein may refer to specific exemplary embodiments, it will be appreciated that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least: (i) enable robots to scan for features within new environments; (ii) improve efficiency of humans working alongside robots by providing them with insightful feature data; and (iii) autonomously identify misplaced or missing features within an environment over time. Other advantages are readily discernible by one having ordinary skill in the art given the contents of the present disclosure.

FIG. 1A is a functional block diagram of a robot 102 in accordance with some principles of this disclosure. As illustrated in FIG. 1A, robot 102 may include controller 118, memory 120, user interface unit 112, sensor units 114, navigation units 106, actuator unit 108, and communications unit 116, as well as other components and subcomponents (e.g., some of which may not be illustrated). Although a specific embodiment is illustrated in FIG. 1A, it is appreciated that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processors (e.g., microprocessors), processing device 138, as shown in FIG. 1B, and other peripherals. As previously mentioned and used herein, processor, microprocessor, and/or digital processor may include any type of digital processing device such as, without limitation, digital signal processors (“DSPs”), reduced instruction set computers (“RISC”), general-purpose (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, and application-specific integrated circuits (“ASICs”). Peripherals may include hardware accelerators configured to perform a specific function using hardware elements such as, without limitation, encryption/description hardware, algebraic processing devices (e.g., tensor processing units, quadratic problem solvers, multipliers, etc.), data compressors, encoders, arithmetic logic units (“ALU”), and the like. Such digital processors may be contained on a single unitary integrated circuit die, or distributed across multiple components.

Controller 118 may be operatively and/or communicatively coupled to memory 120. Memory 120 may include any type of integrated circuit or other storage device configurable to store digital data including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc.

Memory 120 may provide instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the instructions may be configurable to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processor may be on board or internal to robot 102 and/or external to robot 102 and be communicatively coupled to controller 118 of robot 102 utilizing communication units 116 wherein the external processor may receive data from robot 102, process the data, and transmit computer-readable instructions back to controller 118. In at least one non-limiting exemplary embodiment, the processor may be on a remote server (not shown).

In some exemplary embodiments, memory 120, shown in FIG. 1A, may store a library of sensor data. In some cases, the sensor data may be associated at least in part with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configurable to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend at least in part on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., that are commonly associated, such as robots by a common manufacturer, user, network, etc.) may be networked so that data captured by individual robots are collectively shared with other robots. In such a fashion, these robots may be configurable to learn and/or share sensor data in order to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be to various controllers and/or processors. In some embodiments, a single controller (e.g., controller 118) may serve as the various controllers and/or processors described. In other embodiments different controllers and/or processors may be used, such as controllers and/or processors used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power budgets, receive/send network instructions and/or updates, update firmware, send interrogatory signals, receive and/or send statuses, and/or perform any operations for running features of robot 102.

Returning to FIG. 1A, operative units 104 may include various units that perform functions for robot 102. For example, operative units 104 include at least navigation units 106, actuator units 108, user interface units 112, sensor units 114, and communication units 116. Operative units 104 may also comprise other units that provide the various functionality of robot 102. In exemplary embodiments, operative units 104 may be instantiated in software, hardware, or both software and hardware. For example, in some cases, units of operative units 104 may comprise computer-implemented instructions executed by a controller. In exemplary embodiments, units of operative unit 104 may comprise hardcoded logic (e.g., ASICS). In exemplary embodiments, units of operative units 104 may comprise both computer-implemented instructions executed by a controller and hardcoded logic. Where operative units 104 are implemented in part in software, operative units 104 may include units/modules of code configurable to provide one or more functionalities.

In exemplary embodiments, navigation units 106 may include systems and methods that may computationally construct and update a map of an environment, localize robot 102 (e.g., find its position) in a map, and navigate robot 102 to/from destinations. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configurable to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators such as electric motors, gas motors, driven magnet systems, solenoid/ratchet systems, piezoelectric systems (e.g., inchworm motors), magnetostrictive elements, gesticulation, and/or any way of driving an actuator known in the art. According to exemplary embodiments, actuator unit 108 may include systems that allow movement of robot 102, such as motorized propulsion. For example, motorized propulsion may move robot 102 in a forward or backward direction, and/or be used at least in part in turning robot 102 (e.g., left, right, and/or any other direction). By way of illustration, actuator unit 108 may control if robot 102 is moving or is stopped and/or allow robot 102 to navigate from one location to another location. By way of illustration, such actuators may actuate the wheels for robot 102 to navigate a route, navigate around obstacles or move the robot as it conducts a task. Other actuators may repose cameras and sensors. According to exemplary embodiments, actuator unit 108 may include systems that allow in part for task execution by the robot 102 such as, for example, actuating features of robot 102 (e.g., moving a robotic arm feature to manipulate objects within an environment).

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external. In some cases, sensor units 114 may include one or more exteroceptive sensors, such as sonars, light detection and ranging (“LiDAR”) sensors, radars, lasers, cameras (including video cameras (e.g., red-blue-green (“RBG”) cameras, infrared cameras, three-dimensional (“3D”) cameras, thermal cameras, etc.), time of flight (“TOF”) cameras, structured light cameras, antennas, motion detectors, microphones, and/or any other sensor known in the art. According to some exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based at least in part on distance or height measurements. Such data may be stored in data structures, such as matrices, arrays, queues, lists, stacks, bags, etc.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configurable to determine the odometry of robot 102. For example, sensor units 114 may include proprioceptive sensors, which may comprise sensors such as accelerometers, inertial measurement units (“IMU”), odometers, gyroscopes, speedometers, cameras (e.g., using visual odometry), clock/timer, and the like. Odometry may facilitate autonomous navigation and/or autonomous actions of robot 102. This odometry may include robot 102's position (e.g., where position may include robot's location, displacement and/or orientation, and may sometimes be interchangeable with the term pose as used herein) relative to the initial location. Such data may be stored in data structures, such as matrices, arrays, queues, lists, stacks, bags, etc. According to exemplary embodiments, the data structure of the sensor data may be called an image.

According to exemplary embodiments, user interface units 112 may be configurable to enable a user to interact with robot 102. For example, user interface units 112 may include touch panels, buttons, keypads/keyboards, ports (e.g., universal serial bus (“USB”), digital visual interface (“DVI”), Display Port, E-SATA, Firewire, PS/2, Serial, VGA, SCSI, audioport, high-definition multimedia interface (“HDMI”), personal computer memory card international association (“PCMCIA”) ports, memory card ports (e.g., secure digital (“SD”) and miniSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments user interface units 112 may be positioned on the body of robot 102. According to exemplary embodiments, user interface units 112 may be positioned away from the body of robot 102 but may be communicatively coupled to robot 102 (e.g., via communication units including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configurable to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3GPP/3GPP2), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configurable to send/receive signals utilizing a transmission protocol over wired connections, such as any cable that has a signal line and ground. For example, such cables may include Ethernet cables, coaxial cables, Universal Serial Bus (“USB”), FireWire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configurable to send and receive signals comprising numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES, and the like. Communications unit 116 may be configurable to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configurable to manage memory 120, controller 118, power supply 122, modules in operative units 104, and/or any software, hardware, and/or features of robot 102. For example, and without limitation, operating system 110 may include device drivers to manage hardware resources for robot 102.

In exemplary embodiments, power supply 122 may include one or more batteries, including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1A (including memory 120, controller 118, sensor units 114, user interface unit 112, actuator unit 108, communications unit 116, mapping and localization unit 126, and/or other units) may be integrated onto robot 102, such as in an integrated system. However, according to some exemplary embodiments, one or more of these units may be part of an attachable module. This module may be attached to an existing apparatus to automate so that it behaves as a robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used herein below, a robot 102, a controller 118, or any other controller, processor, or robot performing a task illustrated in the figures below comprises a controller executing computer-readable instructions stored on a non-transitory computer-readable storage apparatus, such as memory 120, as would be appreciated by one skilled in the art.

Next referring to FIG. 1B, the architecture of a processor or processing device 138 is illustrated according to an exemplary embodiment. As illustrated in FIG. 1B, the processing device 138 includes a data bus 128, a receiver 126, a transmitter 134, at least one processor 130, and a memory 132. The receiver 126, the processor 130 and the transmitter 134 all communicate with each other via the data bus 128. The processor 130 is configurable to access the memory 132 which stores computer code or computer-readable instructions in order for the processor 130 to execute the specialized algorithms. As illustrated in FIG. 1B, memory 132 may comprise some, none, different, or all of the features of memory 120 previously illustrated in FIG. 1A The algorithms executed by the processor 130 are discussed in further detail below. The receiver 126 as shown in FIG. 1B is configurable to receive input signals 124. The input signals 124 may comprise signals from a plurality of operative units 104 illustrated in FIG. 1A including, but not limited to, sensor data from sensor units 114, user inputs, motor feedback, external communication signals (e.g., from a remote server), and/or any other signal from an operative unit 104 requiring further processing. The receiver 126 communicates these received signals to the processor 130 via the data bus 128. As one skilled in the art would appreciate, the data bus 128 is the means of communication between the different components-receiver, processor, and transmitter-in the processing device. The processor 130 executes the algorithms, as discussed below, by accessing specialized computer-readable instructions from the memory 132. Further detailed description as to the processor 130 executing the specialized algorithms in receiving, processing and transmitting of these signals is discussed above with respect to FIG. 1A The memory 132 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage mediums may include volatile, nonvolatile, dynamic, static, read/write, read-only, random-access, sequential-access, location-addressable, file-addressable, and/or content-addressable devices. The processor 130 may communicate output signals to transmitter 134 via data bus 128 as illustrated. The transmitter 134 may be configurable to further communicate the output signals to a plurality of operative units 104 illustrated by signal output 136.

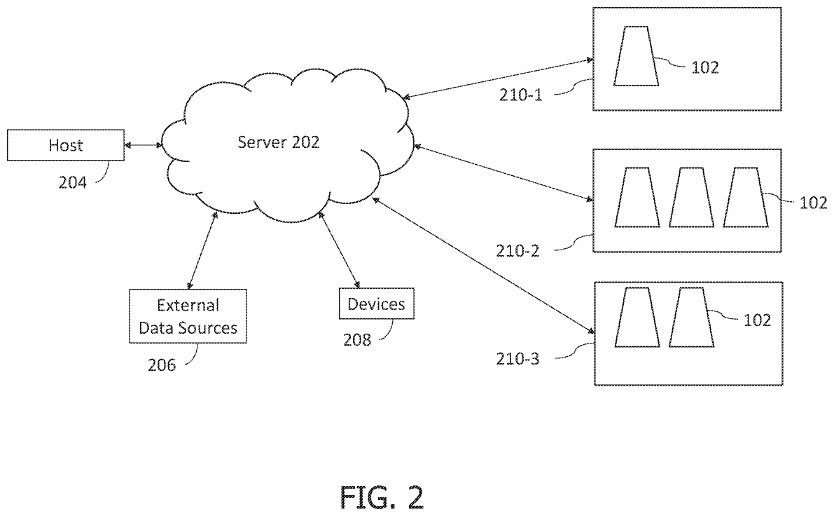

One of ordinary skill in the art would appreciate that the architecture illustrated in FIG. 1B may also illustrate an external server architecture configurable to effectuate the control of a robotic apparatus from a remote location, such as server 202 illustrated next in FIG. 2. That is, the server may also include a data bus, a receiver, a transmitter, a processor, and a memory that stores specialized computer-readable instructions thereon.

One of ordinary skill in the art would appreciate that a controller 118 of a robot 102 may include one or more processing devices 138 and may further include other peripheral devices used for processing information, such as ASICS, DPS, proportional-integral-derivative (“PID”) controllers, hardware accelerators (e.g., encryption/decryption hardware), and/or other peripherals (e.g., analog to digital converters) described above in FIG. 1A The other peripheral devices when instantiated in hardware are commonly used within the art to accelerate specific tasks (e.g., multiplication, encryption, etc.) which may alternatively be performed using the system architecture of FIG. 1B. In some instances, peripheral devices are used as a means for intercommunication between the controller 118 and operative units 104 (e.g., digital to analog converters and/or amplifiers for producing actuator signals). Accordingly, as used herein, the controller 118 executing computer-readable instructions to perform a function may include one or more processing devices 138 thereof executing computer-readable instructions and, in some instances, the use of any hardware peripherals known within the art. Controller 118 may be illustrative of various processing devices 138 and peripherals integrated into a single circuit die or distributed to various locations of the robot 102 which receive, process, and output information to/from operative units 104 of the robot 102 to effectuate control of the robot 102 in accordance with instructions stored in a memory 120, 132. For example, controller 118 may include a plurality of processing devices 138 for performing high-level tasks (e.g., planning a route to avoid obstacles) and processing devices 138 for performing low-level tasks (e.g., producing actuator signals in accordance with the route).

FIG. 2 illustrates a server 202 and communicatively coupled components thereof in accordance with some exemplary embodiments of this disclosure. The server 202 may comprise one or more processing units depicted in FIG. 1B above, each processing unit comprising at least one processor 130 and memory 132 therein in addition to, without limitation, any other components illustrated in FIG. 1B. The processing units may be centralized at a location or distributed among a plurality of devices (e.g., a cloud server or dedicated server). Communication links between the server 202 and coupled devices may comprise wireless and/or wired communications, wherein the server 202 may further comprise one or more coupled antenna to effectuate the wireless communication. The server 202 may be coupled to a host 204, wherein the host 204 may correspond to a high-level entity (e.g., an admin) of the server 202. The host 204 may, for example, upload software and/or firmware updates for the server 202 and/or coupled devices 208 and 210, connect or disconnect devices 208 and 210 to the server 202, or otherwise control operations of the server 202. External data sources 206 may comprise any publicly available data sources (e.g., public databases such as weather data from the National Oceanic and Atmospheric Administration (NOAA), satellite topology data, public records, etc.) and/or any other databases (e.g., private databases with paid or restricted access) of which the server 202 may access data therein. Devices 208 may comprise any device configured to perform a task at an edge of the server 202. These devices may include, without limitation, internet of things (IoT) devices (e.g., stationary CCTV cameras, smart locks, smart thermostats, etc.), external processors (e.g., external CPUs or GPUs), and/or external memories configured to receive and execute a sequence of computer-readable instructions, which may be provided at least in part by the server 202, and/or store large amounts of data.

Lastly, the server 202 may be coupled to a plurality of robot networks 210, each robot network 210-1, 210-2, 210-3 comprising a local network of at least one robot 102. Each separate network 210 may comprise one or more robots 102 operating within separate environments from each other. An environment may comprise, for example, a section of a building (e.g., a floor or room) or any space in which the robots 102 operate. Each robot network 210 may comprise a different number of robots 102 and/or may comprise different types of robot 102. For example, network 210-2 may comprise a scrubber robot 102, vacuum robot 102, and a gripper arm robot 102, whereas network 210-1 may only comprise a robotic wheelchair, wherein network 210-2 may operate within a retail store while network 210-1 may operate in a home of an owner of the robotic wheelchair or a hospital. Network 210-3 may comprise a plurality of robots operating in physically separated environments but associated with a common task, administrator, etc.

For example, network 210-3 may compnse a plurality of security robots operating in different environments that are linked to a central security station. Each robot network 210 may communicate data including, but not limited to, sensor data (e.g., RGB images captured, LiDAR scan points, network signal strength data from sensors 202, etc.), IMU data, navigation and route data (e.g., which routes were navigated), localization data of objects within each respective environment, and metadata associated with the sensor, IMU, navigation, and localization data. Each robot 102 within each network 210 may receive communication from the server 202 or from other robots 102 within the network, either directly or via server 202, including, but not limited to, a command to navigate to a specified area, a command to perform a specified task, a request to collect a specified set of data, a sequence of computer-readable instructions to be executed on respective controllers 118 of the robots 102, software updates, and/or firmware updates. One skilled in the art may appreciate that a server 202 may be further coupled to additional relays and/or routers to effectuate communication between the host 204, external data sources 206, edge devices 208, and robot networks 210 which have been omitted for clarity. It is further appreciated that a server 202 may not exist as a single hardware entity, rather may be illustrative of a distributed network of non-transitory memories and processors.

According to at least one non-limiting exemplary embodiment, each robot network 210 may comprise additional processing units as depicted in FIG. 1B above and act as a relay between individual robots 102 within each robot network 210 and the server 202. For example, each robot network 210 may represent a plurality of robots 102 coupled to a single Wi-Fi signal, wherein the robot network 210 may comprise in part a router or relay configurable to communicate data to and from the individual robots 102 and server 202. That is, each individual robot 102 is not limited to being directly coupled to the server 202 and devices 206, 208.

One skilled in the art may appreciate that any determination or calculation described herein may comprise one or more processors of the server 202, edge devices 208, and/or robots 102 of networks 210 performing the determination or calculation by executing computer-readable instructions. The instructions may be executed by a processor of the server 202 and/or may be communicated to robot networks 210 and/or edge devices 208 for execution on their respective controllers/processors in part or in entirety (e.g., a robot 102 may calculate a coverage map using measurements 308 collected by itself or another robot 102). Advantageously, use of a centralized server 202 may enhance a speed at which parameters may be measured, analyzed, and/or calculated by executing the calculations (i.e., computer-readable instructions) on a distributed network of processors on robots 102 and devices 208. Use of a distributed network of controllers 118 of robots 102 may further enhance functionality of the robots 102 as the robots 102 may execute instructions on their respective controllers 118 during times when the robots 102 are not in use by operators of the robots 102.

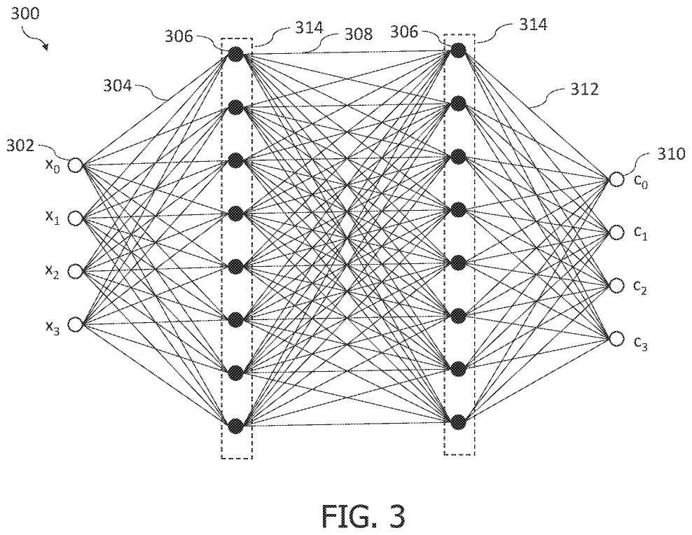

FIG. 3 illustrates a neural network 300, according to an exemplary embodiment. The neural network 300 may comprise a plurality of input nodes 302, intermediate nodes 306, and output nodes 310. The input nodes 302 are connected via links 304 to one or more intermediate nodes 306. Some intermediate nodes 306 may be respectively connected via links 308 to one or more adjacent intermediate nodes 306. Some intermediate nodes 306 may be connected via links 312 to output nodes 310. Links 304, 308, 312 illustrate inputs/outputs to/from the nodes 302, 306, and 310 in accordance with equation I below. The intermediate nodes 306 may form an intermediate layer 314 of the neural network 300. In some embodiments, a neural network 300 may comprise a plurality of intermediate layers 314, intermediate nodes 306 of each intermediate layer 314 being linked to one or more intermediate nodes 306 of adjacent layers, unless an adjacent layer is an input layer (i.e., input nodes 302) or an output layer (i.e., output nodes 310). The two intermediate layers 314 illustrated may correspond to a hidden layer of neural network 300, however a hidden layer may comprise more or fewer intermediate layers 314 or intermediate nodes 306. Each node 302, 306, and 310 may be linked to any number of nodes, wherein linking all nodes together as illustrated is not intended to be limiting. For example, the input nodes 302 may be directly linked to one or more output nodes 310.

The input nodes 306 may receive a numeric value Xi of a sensory input of a feature, i being an integer index. For example, Xi may represent color values of an i^{th} pixel of a color image. The input nodes 306 may output the numeric value Xi to one or more intermediate nodes 306 via links 304. Each intermediate node 306 may be configured to receive a numeric value on its respective input link 304 and output another numeric value ki,j to links 308 following the equation I below:

$$k , 1 = Gi , jXO + bi , jXl + Ci , JX 2 + di , JX 3 \qquad ( Eqn . 1 )$$

Index i corresponds to a node number within a layer (e.g., x1 denotes the first input node 302 of the input layer, indexing from zero). Index} corresponds to a layer, wherein j would be equal to one for the one intermediate layer 314-1 of the neural network 300 illustrated, however,} may be any number corresponding to a neural network 300 comprising any number of intermediate layers 314. Constants a, b, c, and d represent weights to be learned in accordance with a training process. The number of constants of equation I may depend on a number of input links 304 to a respective intermediate node 306. In this embodiment, all intermediate nodes 306 are linked to all input nodes 302, however this is not intended to be limiting. Intermediate nodes 306 of the second (rightmost) intermediate layer 314-2 may output values ki,2 to respective links 312 following equation I above. It is appreciated that constants a, b, c, d may be of different values for each intermediate node 306. Further, although the above equation I utilizes addition of inputs multiplied by respective learned coefficients, other operations are applicable, such as convolution operations, thresholds for input values for producing an output, and/or biases, wherein the above equation is intended to be illustrative and non-limiting.

Output nodes 310 may be configured to receive at least one numeric value ki,j from at least an i^{th} intermediate node 306 of a final (i.e., rightmost) intermediate layer 314. As illustrated, for example, each output node 310 receives numeric values ko-7,2 from the eight intermediate nodes 306 of the second intermediate layer 314-2. The output of the output nodes 310 may comprise a classification of a feature of the input nodes 302. The output Ci of the output nodes 310 may be calculated following a substantially similar equation as equation I above (i.e., based on learned weights and inputs from connections 312). Following the above example where inputs Xi comprise pixel color values of an RGB image, the output nodes 310 may output a classification Ci of each input pixel (e.g., pixel i is a car, train, dog, person, background, soap, or any other classification). Other outputs of the output nodes 310 are considered, such as, for example, output nodes 310 predicting a temperature within an environment at a future time based on temperature measurements provided to input nodes 302 at prior times and/or at different locations.

The training process comprises providing the neural network 300 with both input and output pairs of values to the input nodes 302 and output nodes 310, respectively, such that weights of the intermediate nodes 306 may be determined. An input and output pair comprise a ground truth data input comprising values for the input nodes 302 and corresponding correct values for the output nodes 310 (e.g., an image and corresponding annotations or labels). The determined weights configure the neural network 300 to receive input to input nodes 302 and determine a correct output at the output nodes 310. By way of illustrative example, annotated (i.e., labeled) images may be utilized to train a neural network 300 to identify objects or features within the image based on the annotations and the image itself, the annotations may comprise, e.g., pixels encoded with “cat” or “not cat” information if the training is intended to configure the neural network 300 to identify cats within an image. The unannotated images of the training pairs (i.e., pixel RGB color values) may be provided to input nodes 302 and the annotations of the image (i.e., classifications for each pixel) may be provided to the output nodes 310, wherein weights of the intermediate nodes 306 may be adjusted such that the neural network 300 generates the annotations of the image based on the provided pixel color values to the input nodes 302. This process may be repeated using a substantial number of labeled images (e.g., hundreds or more) such that ideal weights of each intermediate node 306 may be determined. The training process is complete upon predictions made by the neural network 300 falls below a threshold error rate which may be defined using a cost function.

As used herein, a training pair may comprise any set of information provided to input and output of the neural network 300 for use in training the neural network 300. For example, a training pair may comprise an image and one or more labels of the image (e.g., an image depicting a cat and a bounding box associated with a region occupied by the cat within the image).

Neural network 300 may be configured to receive any set of numeric values representative of any feature and provide an output set of numeric values representative of the feature. For example, the inputs may comprise color values of a color image and outputs may comprise classifications for each pixel of the image. As another example, inputs may comprise numeric values for a time-dependent trend of a parameter (e.g., temperature fluctuations within a building measured by a sensor) and output nodes 310 may provide a predicted value for the parameter at a future time based on the observed trends, wherein the trends may be utilized to train the neural network 300. Training of the neural network 300 may comprise providing the neural network 300 with a sufficiently large number of training input/output pairs comprising ground truth (i.e., highly accurate) training data. As a third example, audio information may be provided to input nodes 302 and a meaning of the audio information may be provided to output nodes 310 to train the neural network 300 to identify words and speech patterns.

Generation of the sufficiently large number of input/output training pairs may be difficult and/or costly to produce. Accordingly, most contemporary neural networks 300 are configured to perform a certain task (e.g., classify a certain type of object within an image) based on training pairs provided, wherein the neural networks 300 may fail at other tasks due to a lack of sufficient training data and other computational factors (e.g., processing power). For example, a neural network 300 may be trained to identify cereal boxes within images, however the same neural network 300 may fail to identify soap bars within the images.

As used herein, a model may comprise the weights of intermediate nodes 306 and output nodes 310 learned during a training process. The model may be analogous to a neural network 300 with fixed weights (e.g., constants a, b, c, d of equation I), wherein the values of the fixed weights are learned during the training process. A trained model, as used herein, may include any mathematical model derived based on a training of a neural network 300. One skilled in the art may appreciate that utilizing a model from a trained neural network 300 to perform a function (e.g., identify a feature within sensor data from a robot 102) utilizes significantly less computational recourses than training of the neural network 300 because the values of the weights are fixed. This is analogous to using a predetermined equation to solve a problem compared to determining the equation itself based on a set of inputs and results.

According to at least one non-limiting exemplary embodiment, one or more outputs ki,j from intermediate nodes 306 of a/hintermediate layer 312 may be utilized as inputs to one or more intermediate nodes 306 an m^{th} intermediate layer 312, wherein index m may be greater than or less than} (e.g., a recurrent or feed forward neural network). According to at least one non-limiting exemplary embodiment, a neural network 300 may comprise N dimensions for an N-dimensional feature (e.g., a 3-dimensional input image or point cloud), wherein only one dimension has been illustrated for clarity. One skilled in the art may appreciate a plurality of other embodiments of a neural network 300, wherein the neural network 300 illustrated represents a simplified embodiment of a neural network to illustrate the structure, utility, and training of neural networks and is not intended to be limiting. The exact configuration of the neural network used may depend on (i) processing resources available, (ii) training data available, (iii) quality of the training data, and/or (iv) difficulty or complexity of the classification/problem. Further, programs such as AutoKeras, utilize automatic machine learning (“AutoML”) to enable one of ordinary skill in the art to optimize a neural network 300 design to a specified task or data set.

One skilled in the art may appreciate various other methods for identifying features using other systems different from neural networks 300. For example, features in images may be identified by comparing the images to a library of images which depict such feature. As another example, edge or contour detection may be used to infer what a depicted feature is. It is appreciated that use of a neural network 300 is not intended to be limiting and other conventional methods of feature identification methods known in the art may be utilized in conjunction with or in replacement of a neural network 300.

The following figures describe a method of configuring a robot 102 to scan for features within its environment. As used herein, scanning for features includes the robot 102 capturing images, LiDAR scans, or other sensor unit 114 data of features, objects, items, etc. within its environment to later identify the features, objects, items, etc. based on the acquired sensor data. In some embodiments, the controller 118 of the robot 102 may utilize one or more neural networks 300, or other feature identification methods of this disclosure, to identify features within the acquired sensor data. In other embodiments, one or more processors 130 of a server 202 coupled to the robot 102 may perform the feature identification, wherein the robot 102 transmits the sensor data to the server 202 for analysis. The following systems and methods described herein may be utilized for new robots 102 being deployed to scan for features within a new environment, or for existing robots 102 to expand their capabilities to scan for features in addition to their regular, pre-existing tasks.

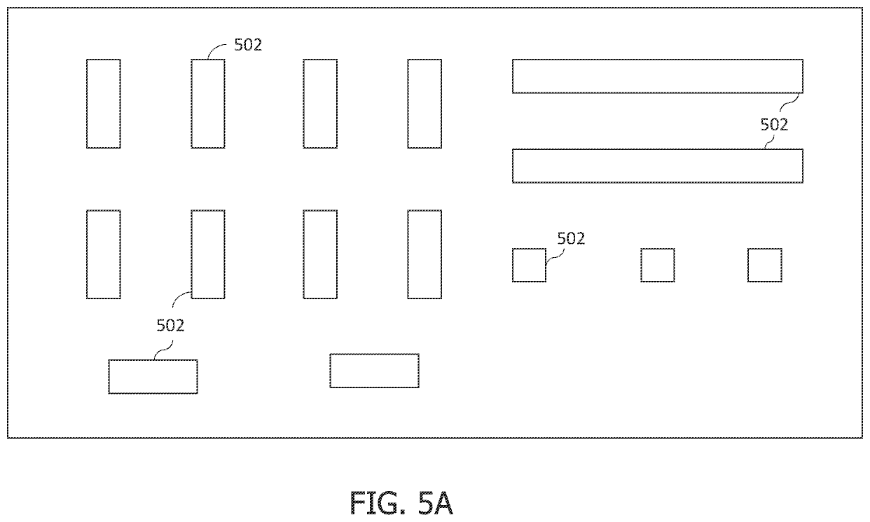

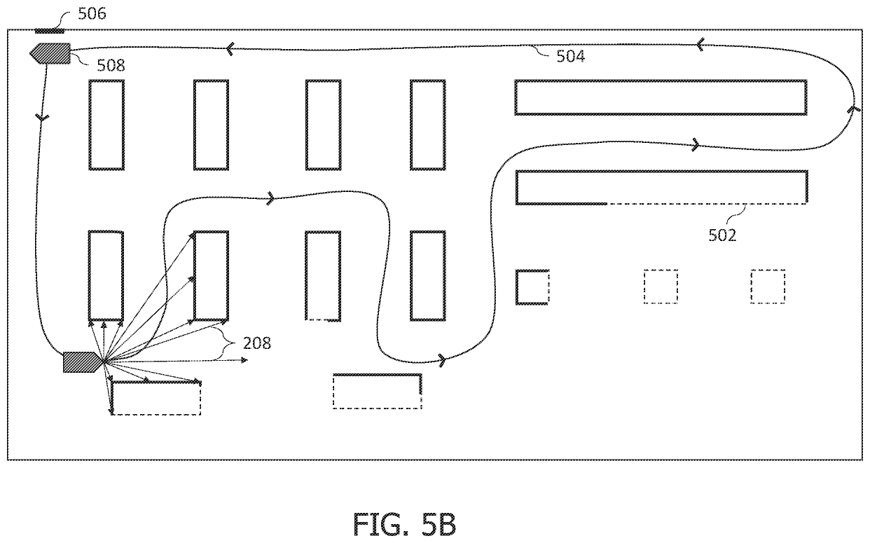

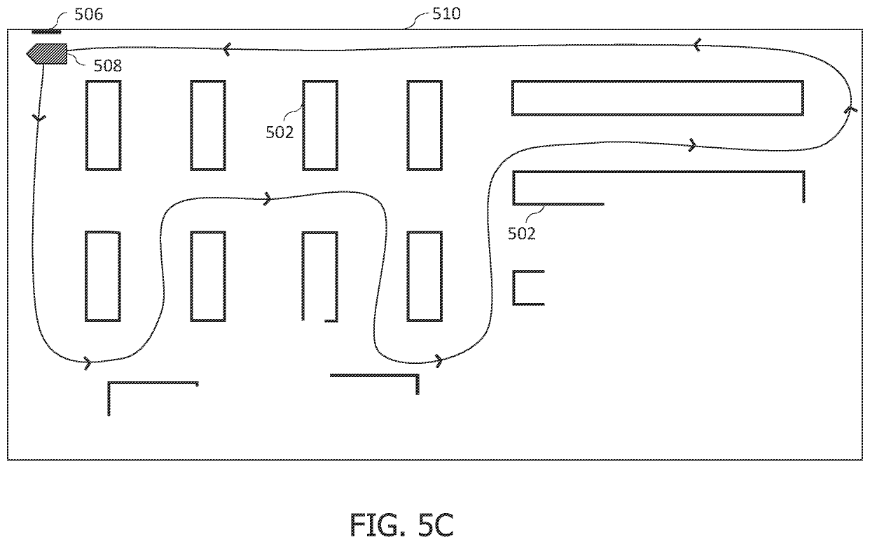

As used herein, a local route or local scanning route includes a route for a robot 102 to navigate, wherein the robot 102 scans for features in acquired sensor data during execution of the local route. In any given environment, there may be one or a plurality oflocal scanning routes based on the size, shape, or configuration of the environment and/or navigation capabilities (e.g., travelable distance) of the robot 102. During navigation of a local route, the robot 102 may produce a computer-readable map of its environment including various objects sensed and localized during execution of the local route. These computer-readable maps may only sense objects within a portion of the environment. Exemplary local scanning routes are shown and described in FIGS. 5A-C below.

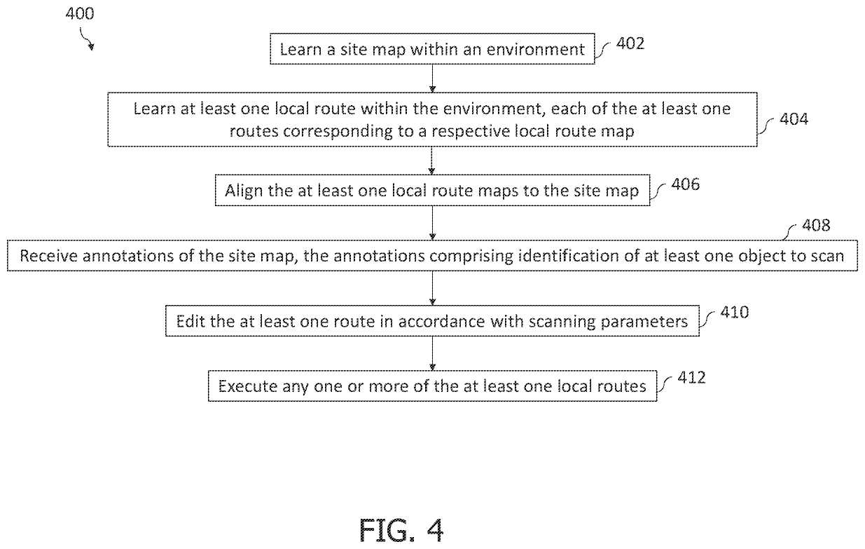

FIG. 4 is a process flow diagram illustrating a method 400 for configuring a controller 118 of a robot 102 to set up an environment to enable the robot 102 to scan for features therein, according to an exemplary embodiment. “New environment,” as used herein, comprises an environment in which the robot 102 has not previously scanned for features and has no prior data of the environment such as, for example, computer-readable maps. That is, the robot 102 may have performed other tasks in the environment, such as cleaning, transporting items, etc., and, upon executing method 400, the robot 102 may additionally or alternatively scan for features. Steps of method 400 may be effectuated via the controller 118 (i.e., processing devices 138 thereof) executing computer-readable instructions from memory 120. It is also appreciated that some of method 400 may be executed on a processing device 138 external to the robot 102, such as a server, provided the necessary data gathered by the robot 102 is able to be communicated to the server for processing.

Block 402 includes the controller 118 learning a site map within the environment. To learn a map, controller 118 may be navigated through its environment to collect data from sensor units 114. The data may indicate the presence/location of various objects in the environment which may be localized onto the site map. The robot 102 may be navigated through the environment via a human driving, pushing, leading, or otherwise manually controlling the direction of the robot 102 while its sensor units 114 collect data and construct a computer-readable site map. According to at least one non-limiting exemplary embodiment, controller 118 may produce the site map via exploring its environment using, for example, area fill patterns or (pseudo-) random walks.

The site map comprises a map of an environment which covers a substantial majority of the area to be scanned for features. The site map is later used to align local route maps to the site map, as described in block 406 below. It may not be required to navigate the robot 102 through the entirety of the environment (e.g., down every aisle in a retail store); rather the robot 102 must sense objects proximate to each of a plurality of local scan routes. For example, if the environment comprises a retail store with a plurality of aisles, the site map may localize the end-caps of the aisles, wherein mapping the entirety of each aisle is not required for reasons discussed below. In short, the site map provides the controller 118 with a large-scale rough view of its entire environment within which the robot 102 will scan for features. This site map will later also be utilized to produce reports of where certain features were detected and located within the entire environment.

The locations of the various objects on the site map may be defined with respect to an origin. In some embodiments, the origin may comprise the start of the route. In some embodiments, the origin may be an arbitrary point within the environment. The robot 102 may recognize its initial position (e.g., upon turning on) based on detecting one or more recognizable features, such as landmarks (e.g., objects sensed in the past), computer-readable codes (e.g., quick-response codes, barcodes, etc.), markers, beacons, and the like. Such markers may indicate the origin point, or may be at a known distance from the origin with respect to which the robot 102 may localize itself Although the site map may include a well-defined origin, various local scanning routes to be executed by the robot 102 may begin at other locations and may be defined with origins at different locations in the environment, wherein the relative location of the origin of the site map and of the local scanning routes may not be well-defined or pre-determined. Accordingly, block 406 discussed below accounts for the various different origins of local scanning routes without prior need for a transform which represents the different origin locations.

Block 404 includes the controller 118 learning at least one local scanning route within the environment, wherein each of the at least one local scanning routes corresponds to a respective local route map. Local routes, or local scanning routes, include the routes navigated by the robot 102 while the robot 102 is scanning for features. Local routes may include a portion of the environment or the entirety of the environment. The controller 118 may learn the local routes via a human operator navigating the robot 102 under manual control. In some embodiments, the controller 118 may receive a local route via wired or wireless transfer from the server 202 and/or from another robot 102 within the environment. In some instances, one or more of the local routes may have existed prior to configuring the robot 102 to scan for features. Local scanning routes may utilize computer-readable maps separate from the site map to effectuate navigation. Local scanning routes may also be learned by the robot 102 in a similar manner including the robot 102 following, being driven, being led, or otherwise being moved through the route. Unlike the global site map in block 402 above, the local scanning route will be a route for the robot 102 to execute in order to scan for features.

During navigation of each of these local routes, controller 118 may produce a corresponding local route map. Local route maps may include various objects sensed and localized by the sensor units 114 of the robot 102. Local route maps may also comprise an origin defined proximate a landmark, recognizable feature, marker, beacon, or similar detectable feature, similar to the origin of the site map. The origins of these local route maps may be at the same or different locations as the origin of the site map. For larger environments, it may be undesirable for the origins or starts of the local routes and site map route to be the same. To define a single origin point for both the site map and local route maps, a process of alignment is performed in block 406.

As used herein, the aggregate area encompassed by the plurality of local route maps where the robot 102 is to scan for features may be referred to as a “scanning environment.” The site map must include one or more objects, or a portion thereof, within the “scanning environment.” As used herein, a “local scanning environment” corresponds to the area of a local route within which the robot 102 is to scan for features during execution of a particular local route.

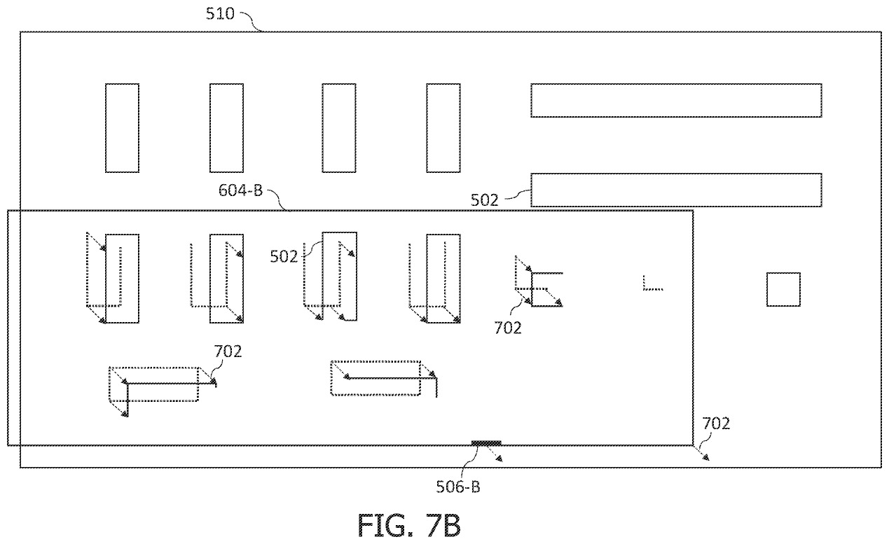

Block 406 includes the controller 118 aligning the at least one local route map to the site map. To align the maps, the controller 118 may determine a transform (i.e., translation and/or rotation) between the origin of the site map and the origin(s) of each of the at least one local route map such that both the site map and the at least one local map align. Controller 118 may utilize iterative closest point (“ICP”) algorithms, or similar nearest neighboring alignment algorithms, to determine the transform, as shown in FIGS. 7A-B below. Once the maps align with minimal error, the controller 118 may define an origin of the local route map with respect to the origin of the site map.

Since the site map includes at least a portion of various objects through the entirety of the scanning environment, some of those same objects, or a portion thereof, on the site map should appear in the local route maps. For any given local route map, the controller 118 may rotate and/or translate the local route map until the objects on the local route map and site map align with minimal discrepancy. In some embodiments, sensor units 114 comprise, at least in part, LiDAR sensors configured to detect the surfaces of objects, wherein the surfaces of the objects in each local route map may be aligned to the same surfaces of the same objects of the site map. Controller 118 may utilize, for example, iterative closest point, scan matching, and/or nearest neighboring algorithms to determine the necessary translations and rotations to align the maps. Upon the various objects on a translated and/or rotated local route map aligning to the site map, the translations and/or rotations performed correspond to the translations and/or rotations between the origin of the site map and the local map. These translations/rotations are stored in memory 120 of the robot 102 for later use in producing a feature scanning report indicating the locations of various detected features on the global site map.

Aligning of the local route maps to the site map may reduce the number of annotations required to be input by a human reviewer to further configure the robot 102 to scan for features in next block 408.

Block 408 includes the controller 118 receiving annotations of the site map, the annotations comprising identification of at least one object to scan. The objects to scan may comprise shelves, displays, and/or storage locations of features to be identified. The annotations may be input by a human who has knowledge of the environment. The annotations may provide context to the features sensed by sensor units 114. The annotations may be further utilized to organize feature scanning results. Annotations received may include, for a retail environment as an example, “produce 1,” “produce 2,” “hardware 2,” “dairy 5,” “cosmetics 1” and so forth. These annotations may provide the controller 118 with context necessary to reduce the number of potentially sensed features from all features within the environment to only features associated with the particular annotation (e.g., only dairy products should be detected in the dairy aisles). Especially for retail environments, annotations alone cannot be used to exclude features from possible detection because misplaced items may be present in an unrelated aisle (e.g., soap in the dairy aisle; clothing apparel in the hardware section, etc.). However, in the case of ambiguous feature identification, these annotations may bias feature identification towards features typically associated with these annotations.

According to at least one non-limiting exemplary embodiment, bin-level annotations may be utilized to further segment a given annotated object into two or more sub-sections, which may represent particular displays, particular items, or other smaller sub-sections referred to herein as bins.

According to at least one non-limiting exemplary embodiment, the annotations may be received via a human providing input to user interface units 112 of the robot 102.

According to at least one non-limiting exemplary embodiment, the controller 118 may communicate the site map to the server 202, wherein a device 208 coupled to the server 202 may be configured to receive the human input comprising the annotations. The annotations may be subsequently communicated back to the robot 102 from the server 202. The same or similar device 208 may also be utilized to identify and remove temporary objects which may have caused changes in the path of the robot 102, as discussed below. The transforms determined in block 406 may also be utilized by the server 202 or device 208 to transfer annotations on the site map to their corresponding objects on each local scanning route map.

According to at least one non-limiting exemplary embodiment of a retail environment, products may be displayed on a store floor. That is, the products may be placed (e.g., on a pallet) on the floor, rather than on shelves or displays. Although annotations described herein relate to an object, such as a shelf or display, annotations may also encompass arbitrary areas within the environment within which features are desired to be scanned. These types of annotations may also be useful in adapting to store layout changes.

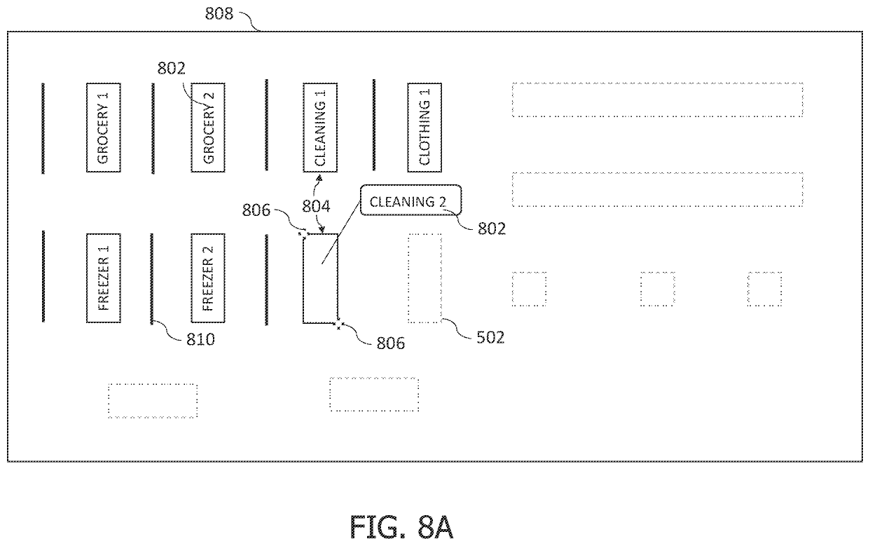

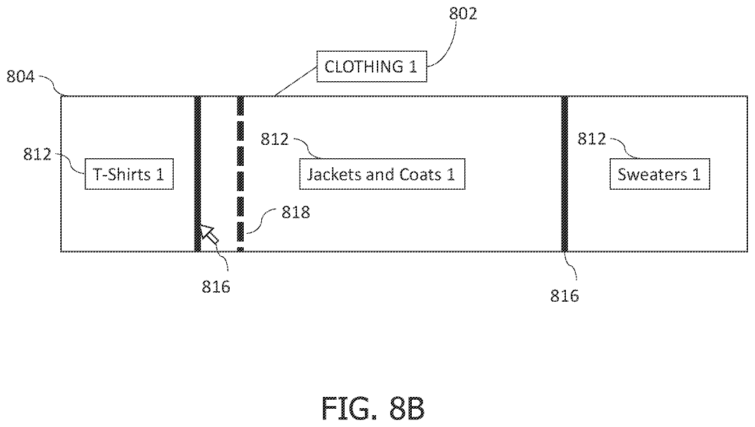

A visual depiction of a human providing the user input to annotate the site map is shown and described in FIG. 8A-B below. The annotations identify the area occupied by objects which are to be scanned for features. Advantageously, due to the alignment, each of the at least one local maps also correctly identifies the area occupied by these objects, defined about either the site map origin or the local map origin.

Block 410 includes the controller 118 editing the at least one route in accordance with scanning parameters. Scanning parameters, as used herein, may correspond to any behavior, location, or movement of the robot 102 which affects the quality of sensor data which represents the features to be scanned. For example, the distance from features at which the robot 102 should image those features to produce non-blurry and resolvable images may be predetermined based on the intrinsic properties of the image camera (e.g., focal length). If any of the at least one local routes includes the robot 102 navigating too close or too far from an annotated object, the controller 118 may edit the route to cause the route to be within a desirable range to acquire high-quality images. In a similar manner, speed of the robot 102 may be adjusted based on the camera properties (e.g., shutter speed, lighting parameters, etc.) to reduce motion blur. Another parameter may include orientation of the robot 102, more specifically its camera which, ideally, should image objects at a normal angle to avoid edge-effects, distortions, and blur in images.

In embodiments where feature identification is performed using range data or point cloud data from the robot 102 (e.g., from LiDAR sensors and/or depth cameras), the distance between the robot 102 and annotated objects to be scanned may be configured to ensure sufficiently dense point cloud representations of the features such that the features are readily identifiable.

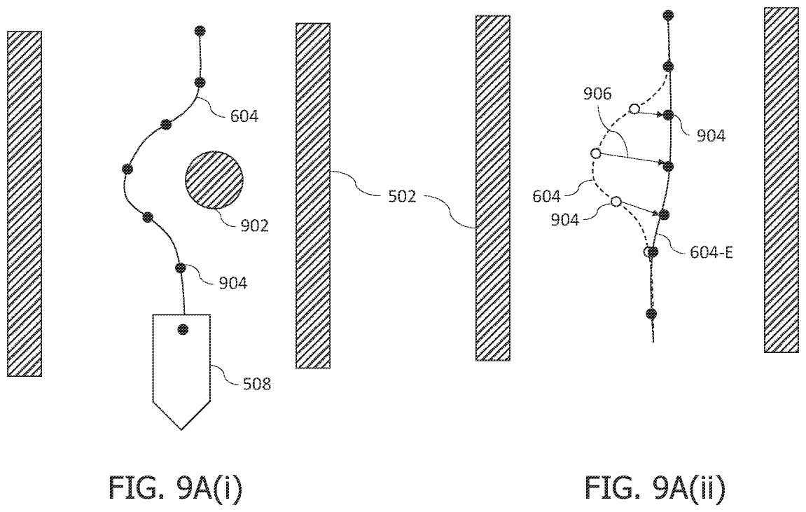

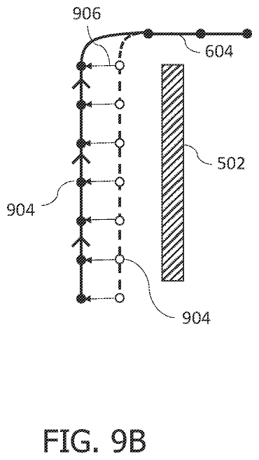

In some instances, during navigation of any of the at least one local routes, the robot 102 may be required to navigate around temporary objects. The navigation around these objects may not be a desirable learned behavior since these objects may not exist at later times, wherein navigating around where the object was during training may not be desirable. Accordingly, the controller 118 may identify temporary objects based on their presence, or lack thereof, on the site map and adjust the route accordingly, as shown in FIG. 9A (i-ii) for example. In some embodiments, the user interface units 112 of the robot 102 may be configured to receive a human input to identify a temporary object, wherein the temporary object may be removed from the local map upon being identified as temporary.

According to at least one non-limiting exemplary embodiment, the controller 118 may navigate each of the at least one local routes to determine optimal scanning parameters automatically. During navigation of a local route, the controller 118 may identify portions of the local route where blurry images or other low-quality data is captured. Low-quality data may be identified based on detection of blur or based on an inability of the robot 102 or server 202 to identify features using the data. These portions may be adjusted automatically or manually via user interface input to enhance the quality of the sensor data. For instance, the controller 118 may modify any of the above discussed parameters (e.g., speed, distance, angle, etc.) to achieve the higher image quality.

According to at least one non-limiting exemplary embodiment, sensor units 114 may include an RFID reader configured to read from nearby RFID tags. The RFID tags may be affixed to, embedded within, or proximate to features to be scanned. The RFID tags may transmit information relating to that feature (e.g., a product ID, shelf-keeping unit (SKU), or similar) to the RFID reader of the robot 102. Accordingly, route edits may cause the robot 102 to navigate sufficiently close to the scanned features such that the RFID reader is within range of the RFID tags.

Block 412 includes the controller 118 executing any of the at least one local routes. During execution of these at least one local routes, the controller 118 may aggregate sensor data collected when proximate an annotated object. It may be desirable to identify the features in the sensor data after the robot 102 has completed its navigation since feature identification may occupy a substantial portion of computational resources of the controller 118 (e.g., CPU threads used, time, memory, etc.). It may also be desirable for the same reasons to utilize one or more processors 130 of an external server 202 coupled to the robot 102 to perform the feature identification. The annotations provided enable the controller 118 to determine when and where to collect data of the features to be identified, greatly reducing the amount of data to be processed.

According to at least one non-limiting exemplary embodiment, sensor data associated with an annotated object may be stored separately from sensor data of other annotated objects. The data may be differentiated using metadata, encoding, or binning. Separating the sensor data of each individual annotated object may be useful in later reviewing of the feature data. For example, upon identifying all the features along a local scanning route, it may be discovered that “dairy 1” may have substantially higher turnover than “dairy 2.” This insight may be useful in, for example, rearranging “dairy 2” to increase turnover in a similar way as “dairy 1” or may be useful in maintaining stock in “dairy 1.”

The following figures provide detailed and visual exemplary embodiments of the various steps executed by the controller 118 in method 400. Starting with FIG. 5A, FIG. 5A depicts an exemplary environment comprising a plurality of objects 502 therein in accordance with the exemplary embodiments of this disclosure. FIG. 5A is intended to be a visual reference of the environment illustrating the true locations of the various objects 502. The specific arrangement of the objects 502 is not intended to be limiting. For simplicity, the entirety of the environment shown in FIGs. SA-C may be considered as a scanning environment. For example, the environment may comprise a retail store, wherein the objects 502 may correspond to shelves or displays for products. One skilled in the art may appreciate that, from the perspective of the robot 102, none of the objects 502 shown are known to be present at their illustrated locations.

FIG. 5B illustrates a site map of an environment (block 402) shown previously in FIG. 5A produced by a robot 102, according to an exemplary embodiment. The robot 102 is shown on the map using a footprint 508 which digitally represents the area occupied, location, and orientation of the robot 102 in its environment at various points in time. To produce the site map, the robot 102 is navigated along route 504. FIG. 5B depicts two footprints 508 illustrative of the robot 102 being in two different locations: (i) the start of the route 504 and (ii) partway along the route 504. The start of the route 504 may be defined by the robot 102 detecting its initial location based on sensing a familiar landmark 506, such as a quick-response code, barcode, pattern, notable object, beacon, or similar. The landmark 506 may be input by a user during a training phase to associate the route 504 executed with a particular landmark 506. The location of the landmark 506 or the location of the robot 102 upon sensing the landmark 506 may define the origin of the site map. In some embodiments, the origin may be in a separate location from the landmark 506.

Robot 102 may navigate along route 504 under user-guided control, wherein a human operator may push, pull, drive, lead, or otherwise cause the robot 102 to navigate the path of route 504. The route 504 may cause the robot 102 to sense at least a portion of the objects 502 within the environment. As shown by the footprint 508 in the bottom left of FIG. 5B, a plurality of beams 208 from a LiDAR sensor may reflect off the surfaces of objects 502 along the line of sight of the LiDAR sensor to localize the surfaces of the objects. Emboldened portions of the objects 502 are illustrative of the surfaces sensed by the LiDAR sensor and dashed lines illustrate unsensed portions of the objects 502. As shown, a substantial majority of the objects are at least in part detected during navigation of the site map route 504. Route 504 is illustrated as a closed-loop, but in some non-limiting exemplary embodiments, the route 504 may begin and end in different locations.

According to at least one non-limiting exemplary embodiment, the route 504 may be navigated autonomously by the robot 102 using an exploration mode. The exploration mode may include the robot 102 performing a random or pseudo-random walk or via filling in a predefined area or perimeter.

FIG. 5C illustrates the completed site map subsequent to execution of the route 504 by the robot 102 shown in FIG. 5B, in accordance with some non-limiting exemplary embodiments of this disclosure. Comparing the site map in FIG. 5C with the ground truth shown in FIG. 5A, most of the environment has been navigated and the objects therein have been at least partially detected. The objects 502 which are at least partially detected correspond to objects or locations desired to be scanned for features by the robot 102.

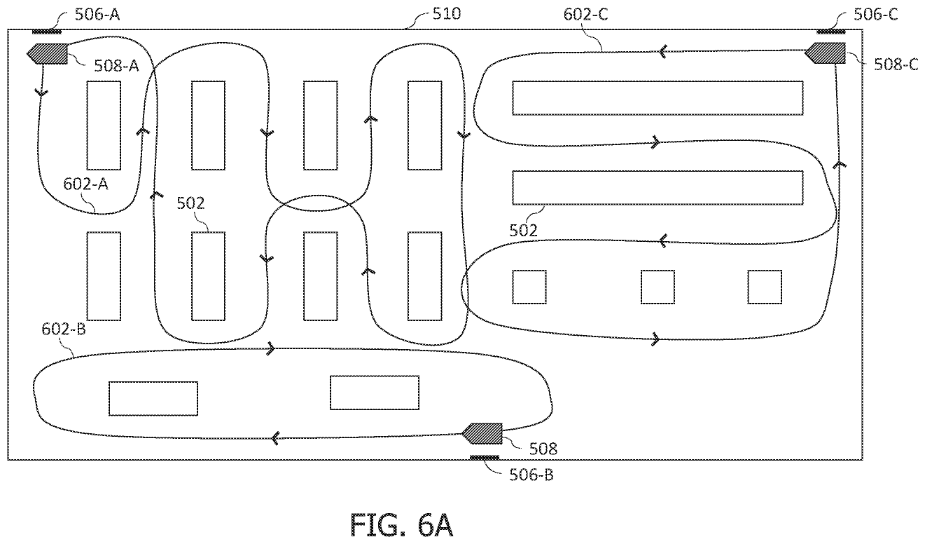

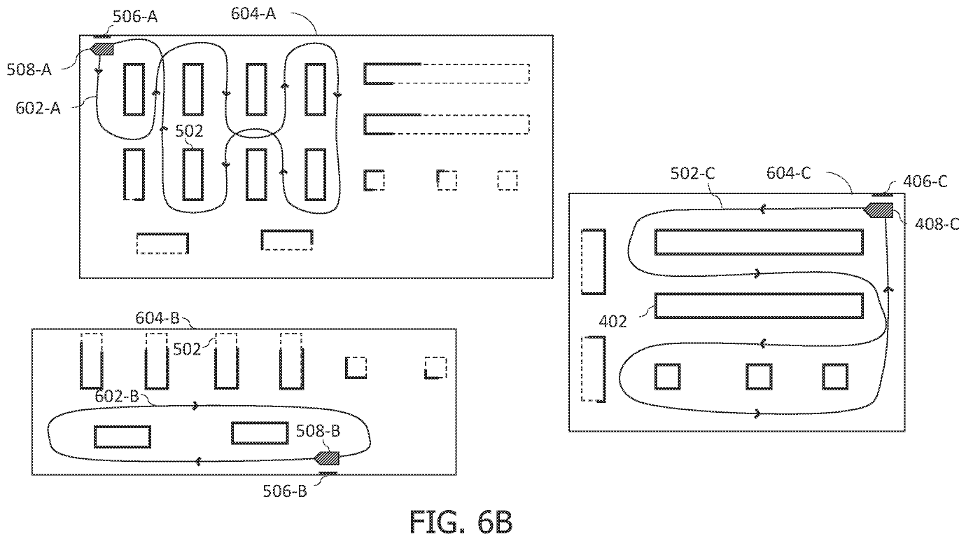

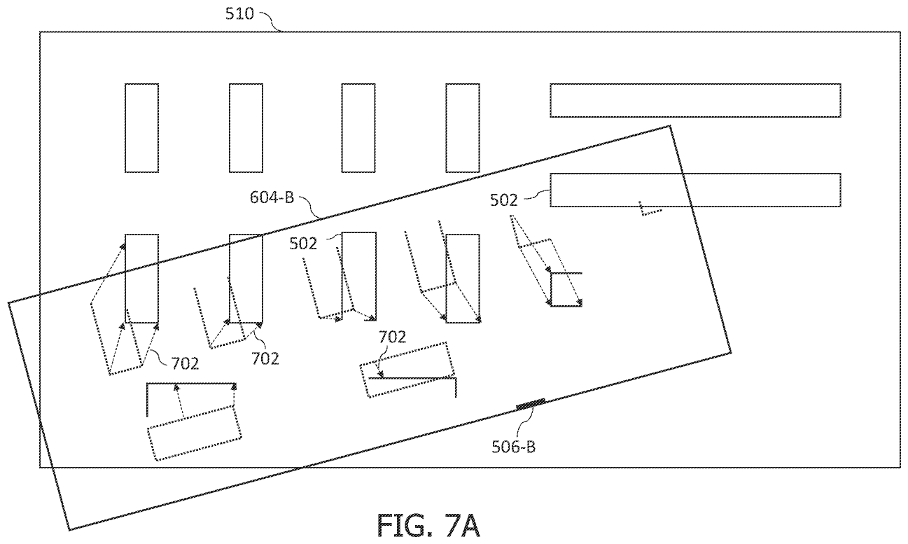

FIGS. 6A-B illustrate the production of various local scanning routes 602-A, 602-B, and 602-3 (block 404), according to an exemplary embodiment. Three local routes are depicted, however one skilled in the art may appreciate that more or fewer local routes 602 may be defined. Additionally, the specific path of the routes 602 are not intended to be limiting.

The robot 102 may learn the various local scanning routes 602 in a similar way as the site map route 504, wherein a human operator may navigate the robot 102 through the routes 602 to demonstrate the movements the robot 102 should execute during scanning. In some instances, the local routes 602 may be pre-existing routes with pre-existing maps associated therewith. Each local route 602 may begin at a corresponding landmark 506. For example, local route 602-A begins proximate to landmark 506-A. In some instances, multiple local routes 602 may begin proximate a same landmark. During navigation of each of the local routes 602, the controller 118 may produce a computer-readable map comprising the locations of the various objects 502 sensed during the navigation. These computer-readable maps may each include an origin defined proximate to a corresponding landmark 506, or other known location from the landmark 506. The relative locations of the landmarks 506-B, 506-C with respect to landmark 506-A (i.e., the origin of the site map) may not be known and may be difficult to accurately measure. It is appreciated that in executing any one of the three illustrated local scanning routes 602-A, 602-B, 602-C the robot 102 may not sense one or more objects 502 or landmarks 506 which appear on the site map 510.

FIG. 6B illustrates the three computer-readable maps 604-A, 604-B, 604-C associated with the three respective local scanning routes 602-A, 602-B, 602-C shown above in FIG. 6A, according to an exemplary embodiment. The three maps 604-A, 604-B, 604-C are shown as disjoint and separate to show that the controller 118 of the robot 102 does not comprise prior knowledge of the spatial relationship of these three maps 604-A, 604-B, 604-C. For instance, map 604-B does not localize the landmark 506-A used for route 602-A. During navigation of each local route 602-A, 602-B, 602-C, the sensor units 114 of the robot 102 may sense various objects 502 at least partially. The sensed surfaces of the objects, e.g., via a LiDAR sensor, are shown in bold solid lines, while the unsensed surfaces (with reference to FIG. 5A above) are shown with dashed lines for visual clarity and reference for later figures. The local maps 604-A, 604-B, 604-C may each comprise maps of a portion of the environment or the entirety of the environment. Provided that each of the local maps 604-A, 604-B, 604-C include at least a portion of at least one object localized in the site map, controller 118 may be able to align the local maps 604-A, 604-B, 604-C to the site map.

FIGS. 7A-B illustrates the alignment of a local scanning route map 604-B associated with a local scanning route 602-B shown in FIGS. 6A-B and described in block 406 of FIG. 4 above to a site map produced in FIG. 5B-C above, according to an exemplary embodiment. Solid lines represent objects 502 sensed on the site map 510 and dashed lines represent the portions of the objects 502 sensed during production of the local map 604-B. First, returning briefly to FIG. 6A, during execution of route 604-B, controller 118 may receive sensor data indicating the presence and location of various objects 502, or portions thereof, within the environment. Specifically, four vertically oriented (as shown in the figure) rectangular objects 502 are sensed partially, two horizontally oriented rectangular objects 502 are sensed entirely, and only corner portions of square objects 502 are sensed.

FIG. 7A illustrates an initial placement of the local scanning map 604-B onto the site map 510 at an arbitrary location. In some embodiments, the initial location may be a random location on the site map, a pseudo random location on the site map, or a location based on reasonable assumptions/constraints of the environment, however the initial placement of the map 604-B is not intended to be limited to any specific location. In some embodiments, the initial location may be determined by assigning the origin of the local scanning map 604-B to the same location as the origin of the site map. Alignment algorithms utilized, such as iterative closest point (ICP) or variants thereof, may additionally utilize many initial locations to determine the best alignment solution.

Starting with the local map 604-B in its illustrated position/orientation, controller 118 may, in executing ICP alignment algorithms, determine corresponding points on the objects 502 for both maps 510, 604-B. To determine a transform which causes alignment of the local scanning map 604-B to the site map 510, the controller 118 may perform ICP via minimizing distances between points of objects on the site map 604-B and their nearest neighboring point on the site map 510, wherein perfect alignment would include no distance between the two nearest neighboring points. To illustrate, arrows 702 span from a point on an object 502 on the local map 604-B to its corresponding location on the same object 502 on the site map 510. Arrows 702 may represent the ideal transform determined by the controller 118 which causes the map 604-B to align with the site map 510, wherein aligning the map 604-B to the site map 510 includes minimizing the magnitude of distance measures between nearest neighboring points of objects on the site map 604-B to objects on the site map 510. As shown, the arrows 702 comprise varying magnitudes and directions which indicate to the controller 118 that the local map 604-B needs to be rotated. Accordingly, controller 118 may apply iterative small rotations and, upon detecting a decrease in the summed magnitudes of the arrows 702, continue to rotate the map 604-B until the error (i.e., magnitude of arrows 702) begins to increase again (i.e., a gradient descent).

It is appreciated that the arrows 702 illustrated are representative of the ideal transformation needed to align the local scanmng map 604-B to the site map 510. In determining such ideal transform, the controller 118 may iteratively attempt to minimize nearest-neighboring distances, wherein the minimal nearest neighboring distances would correspond to the transform shown by arrows 702.

FIG. 7B shows the local scanning map 604-B having been rotated by the controller 118. After the rotation is applied, all of the arrows 702 include the same magnitude and direction, indicating a translation is required to align the two maps 510, 604-B. The rotations and translations performed by the controller 118 may be utilized, at least in part, to redefine the location of the origin of map 604-B with respect to the origin of the site map 510. The alignment of the local map 604-B, and other local maps 604-A and 604-C, may enable the controller 118 of the robot 102 to translate annotations on a site map 510 to each local map 604-A, 604-B, 604-C.

Advantageously, the use of ICP or similar alignment algorithms enable the controller 118 of the robot 102 to perform the alignment using only partial representations of the objects 502 within the environment. This enables operators of the robot 102 to save time in producing both the site map 510 and training the local routes 602 by allowing for operators to skip certain areas of the environment where (i) scanning is not performed, or (ii) where the environment is complex and objects therein are already partially sensed. The site maps may still require the robot 102 to sense at least a portion of an object 502 seen previously on the site map 510.

FIG. 8A illustrates the annotation of a site map 808 as described in block 408 in FIG. 4 above, according to an exemplary embodiment. FIG. 8A may illustrate a display on a user interface unit 112 of the robot 102 or user interface coupled to the robot 102 (e.g., a personal computer or device 208 coupled to a server 202). According to at least one non-limiting exemplary embodiment, the aligned site map 510 and local scanning route maps 604 may be communicated to a server 202, wherein a device 208 coupled to the server 202 may be configured to receive the annotations. In some embodiments, the one or more local scanning route maps 604 may be overlaid on top of the site map 510 to display all of the objects 502 in the environment, even if some objects 502 are only partially sensed on the site map 510.

The annotations of objects 502 may include (i) a defined boundary 804 of the object, (ii) a label 802 for the object, and (iii) an associated scanning segment 810. First, the boundaries 804 of the objects 502 may be defined. A human annotator may be provided the site map 808 on a user interface (e.g., on the robot 102 or on a device 208 coupled to a server 202) and provide bounding points 806 to define the boundaries 804 of the objects 502. In some embodiments, the bounding points 806 define two opposing corners of a rectangle which can be drawn via clicking and dragging from one corner to another. In some embodiments, bounding points 806 may each define a corner of the objects 510 and be connected by straight line segments. In some embodiments, bounding points 806 may be replaced with other forms of receiving a user input to define the boundaries 804 of objects 502, such as free-form drawing, circular or other predetermined template shapes, connected straight line segments, and the like provided each bounded object is a closed shape.

Once the boundaries 804 of an object 502 are defined, the annotator may provide a label 802 to the object. The labels 802 are environment-specific and can be written as human-readable text, wherein the illustrated labels 802 are exemplary and non-limiting. For example, the environment may comprise a retail store, wherein the bounded objects 502 may correspond to shelves or displays for products. Accordingly, the annotator may provide corresponding annotations which provide context. To illustrate, the cleaning aisles may be labeled “Cleaning l” and “Cleaning 2,” the grocery aisles may be labeled “Grocery 1” and “Grocery 2,” and so forth. When each and every object 502 which is desired to be scanned for features has been annotated, the annotator may subsequently input scanning segments 810 associated with each bounded and now annotated object 502.

Scanning segments 810 indicate an area within which the robot 102 should navigate while it scans for features of the annotated objects 502. The scanning segments 810 may be associated with one or more annotated objects 502. For example, the top-leftmost segment 810 may comprise the “Grocery 1” segment 810, indicating that, when the robot 102 is proximate that segment 810, the controller 118 should capture feature data related to grocery products. During execution of a local scanning route 602, if controller 118 detects the robot 102 is within a threshold distance from a scanning segment 810, the controller 118 may collect data useful for identifying features, such as images, videos, LiDAR/point cloud data, thermal data, and/or any other data collected by sensor units 114.

According to at least one non-limiting exemplary embodiment, scanmng segments 810 may be configured automatically based on sensory requirements needed to scan for features of the annotated objects 502. For instance, if the robot 102 is acquiring images of the features, the scanning segments 810 may be configured automatically at a distance from the object 502 boundary which yields the highest quality (e.g., in focus) images, which may be a predetermined distance specific to the camera configuration.

According to at least one non-limiting exemplary embodiment, robot 102 may be configured to capture feature data with a directional requirement. For example, robot 102 may only include image cameras facing rightward configured to capture images as the robot 102 drives past the features. Accordingly, the direction of travel of the robot 102 must be considered when providing segments 810. To illustrate using the segment 810 between the “Grocery 1” and “Grocery 2” objects, the segment 810 may be encoded such that, if the robot 102 is traveling upwards as depicted in the figure, the robot 102 scans “Grocery 2,” whereas if the robot 102 is traveling downwards, the robot 102 scans “Grocery 1.”

According to at least one non-limiting exemplary embodiment, scanmng segments 810 may be replaced with scanning areas. Scanning areas comprise two-dimensional regions wherein the robot 102, if present within the scanning area, should scan for features. Scanning areas may be defined in a similar way as the boundaries 804 of objects 502. Scanning areas may be associated with one or more annotations 802 in a similar way as the scanning segments 810.

According to at least one non-limiting exemplary embodiment, the annotations may carry additional scanning parameters for the robot 102 to follow during scanning of the object 502. For instance, when imaging freezer sections with glass windows, the flash/lights of a camera system should be disabled to avoid glare. Conversely, if the object to be imaged is underneath a shelf with dim lighting, the lights should be enabled or increased above average luminance levels. Such additional functionalities or behaviors may be encoded into the annotations via, e.g., the annotator selecting from a plurality of preset options.

These annotations may be useful to the robot 102 during scanning by providing relevant context (e.g., robot 102 would expect to find produce in the grocery aisles and not in the cleaning aisles) and useful to report the detected features in an organized, human understandable way described further below.

Advantageously, due to the prior alignment of the local maps to the site map, the controller 118 may translate any and all annotations 802 and scanning segments 810 provided to the site map to each individual local map without requiring the human annotator to annotate each object multiple times for multiple local scanning routes 604.

FIG. 8B illustrates bin-level annotations 812 of an annotated object 502, according to an exemplary embodiment. As shown in FIG. 8A above, many objects 502 may be assigned annotations 802. In addition to the annotations 802 which define scannable objects 502, bin-level annotations 812 may be further utilized to improve feature detection and reporting accuracy. The exemplary object 502 in the illustrated embodiment is a clothing shelf/aisle containing t-shirts, jackets and coats, and sweaters, although one skilled in the art may appreciate any classification of objects to be scanned may be used for bin level annotations 812. A bin, as used herein, comprises a section of a scannable object 502 such as a section of shelf, a certain display, or other sections within a single scannable annotated object 502. Bin level annotations may provide additional specificity in reports of the features detected as well as give more specific directions to humans working alongside the robot(s) 102 to replace, restock, or move items.

The bins are separated by segments 814 which may be drawn vertically as shown or horizontally if so desired. Each segment 814 defines at least two regions which then may receive respective bin-level annotations 812 therein. Users may edit the location of the segments 814 to better reflect the true size/shape of the bin in the physical world, as shown by a user moving a segment 816 from an initial location 818 via a cursor 816. In the illustrated example, the segments 816 may separate t-shirts from jackets and coats sections. The width of the segments 816 is enlarged for clarity, however it is appreciated that the width of the segments 816 is zero and the segments 816 define boundaries of bins.

In some instances, a single annotated object 502 may include different bins on either side of the object 502. For instance, the rectangular ‘Clothing l’ shelf shown may have jackets, t-shirts, and sweaters separated as shown on one side while on its other side the clothing bins may be different (e.g., socks, pants, shoes, etc.). A user may either define two rectangular boundaries representative of, e.g., ‘Clothing l’ on one side and ‘Clothing 2’ on the opposing side, wherein respective bins may be assigned thereafter. Alternatively, bins may be configured as a side-specific annotation and be associated with a respective scanning segment 810 on a particular side of the object 502, wherein the orientation of the robot 102 viewing the object 502 determines which bins the robot 102 is sensing.

In addition to more resolute reporting, wherein specific items may be tracked (e.g., a misplaced item, low stock item, etc.) to a particular location within an environment (more specifically, a location on an object 502), the binning may improve feature detection. For instance, detecting all features within a large panoramic view of the entire Clothing 1 shelf may occupy a substantial amount of processing bandwidth. Binning of the object 502 may improve feature detection within the bins by enabling processing of less data for a given input to a neural network model.

FIG. 9A (i-ii) illustrate edits performed to a route 902 in accordance with block 410 of method 400, according to an exemplary embodiment. Two types of route edits may be performed: (a) manual edits based on user inputs to user interface units 112, and (b) automatic edits. First, FIG. 9A (i) shows an exemplary scenario where a robot 102, in learning a local scanning route 604, encounters an object 902. The object 902 may be a temporary object which does not persist within the environment. For example, the object 902 may be a human, a shopping cart, a puddle of water, and so forth. The human operator, during training/demonstration of the local route 604, may navigate around the temporary object 902 and produce a curve in route 604 around the object 902. The curve route 604 was only executed to avoid collision and is not an indented behavior of the robot 102 to be learned. If the robot 102 is to scan for features of objects 502 (e.g., objects on a shelf) the curve may be undesirable as the robot 102 may capture sensor data of the object 502 at poor angles and from farther distances. Accordingly, the human operator may be prompted to perform edits to the route 604 after completing the training to enhance the feature scanning. The human operator may utilize the user interface 112 of the robot 102 or a separate user interface, such as a user interface on a device 208 coupled to a server 202 or directly coupled to the robot 102.

The edits performed comprise the user moving one or more route points 904 from their learned position in FIG. 9A (i) to their desired positions shown in FIG. 9A (ii). Route points 904 may comprise discretely spaced points along the route 604. The points 904 may be equally spaced in distance along the route 604 or equally spaced based on travel time between two sequential points 904. The route 604 may be defined using a linear or non-linear interpolation between sequential points 904. To edit the route 604, the operator may drag or move the points 904 to edit the route 604, as shown by arrows 906. White points 904 represent the old position of the route points, and black points 904 represent their edited final positions. As shown, the edited route 604-E is substantially straighter than the learned behavior shown in FIG. 9A (i), although the route is not perfectly straight due to the imprecision of human inputs.

According to at least one non-limiting exemplary embodiment, the user interface units 112 may receive an input which identifies object 902 as a temporary object. Following this identification, the controller 118 may remove the object 902 from the map. Once the object 902 is removed from the map, controller 118 may automatically perform the edits shown next in FIG. 9A (ii) automatically in order to (i) shorten the route 604, and (ii) ensure the sensor data of objects 502 is of high quality (i.e., free from blur, with proper magnification/distance, etc.), described further in FIG. 9B as well.

FIG. 9B illustrates automatic route edits performed in accordance with scanning parameters of the robot 102, according to an exemplary embodiment. Scanning parameters may include, for example, distance between the robot 102 and a scannable object 502 such that images, or other sensor data, captured by the robot 102 are of good quality, depict a sufficient number of features, are free from blur, and are captured close enough such that details of the features may be resolved by the camera. For images, it is further beneficial to have all images of an object 502 be captured at the same angle to avoid distortions. Similar considerations may be made for other sensor modalities, such as LiDAR point clouds and thermal image data.

In some instances, human operators may train a scanning route 604 not in accordance with proper scanning parameters due to imprecision in human inputs. Specifically, the human operator may navigate the robot 102 too close to a scannable object 502, as shown by the series of white points 904 illustrative of the trained behavior by the operator. In some instances the robot 102 may be navigated too far from the object 502 or at a non-parallel angle from the scannable (i.e., leftmost) surface of the object 502. If the robot 102 navigates the trained route, the sensor data collected may be of poor quality and depict fewer features than desired due to the closer distance. Controller 118 may automatically check that, for each point 904 along the route 604, the point 904 is within a threshold range from its nearest scannable object 502. The threshold range may include a maximum and minimum distance from which the robot 102 may capture high quality feature data. Such threshold range may be a predetermined value stored in memory 120 based on intrinsic properties of the sensors used to capture data of the features, such as focal length of cameras or resolution ofLiDARs. In some embodiments, controller 118 may perform as few edits as possible to the route 604 in order to avoid causing the robot 102 to execute undesirable behavior which deviates substantially from the training. The route may additionally be straightened and parallelized to either the scannable surface of the object 502 or its corresponding scanning segment 810 (not shown).

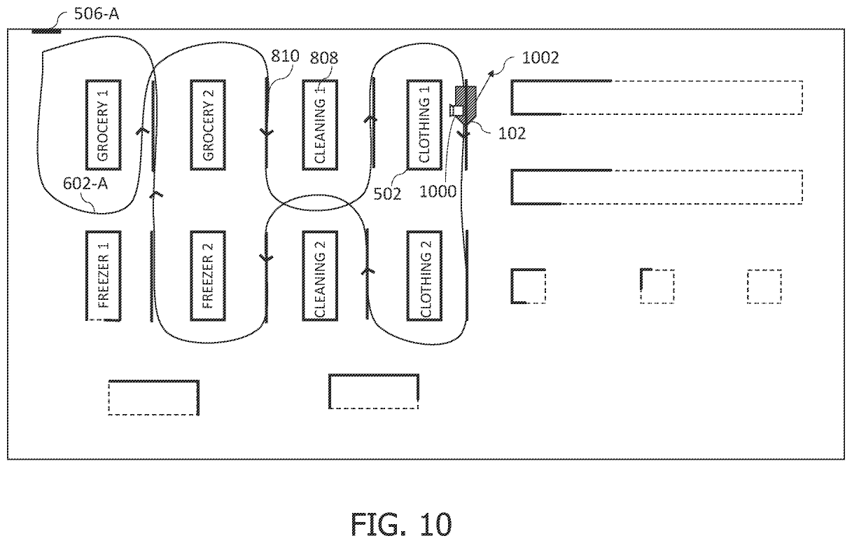

FIG. 10 illustrates a robot 102 executing a local scanning route 602-A following execution of method 400 in FIG. 4 (i.e., block 412), according to an exemplary embodiment. As shown, the route 602-A navigates the robot 102 proximate to a plurality of now annotated objects 502 and nearby/along corresponding scanning segments 810. In this exemplary embodiment, the robot 102 is equipped with an imaging camera 1000 configured to capture images of features on the right-hand side of the robot 102 as the robot 102 moves past the objects 502. Upon being proximate to a scanning segment 810, controller 118 may begin collecting images of an associated scannable/annotated object 502 and, in some embodiments, navigate along the straight line segment 810. Images captured may be stored in a file, bin (e.g., corresponding to bins described in FIG. 8B), directory, or portion of memory 120 associated with the annotation of the scannable object 502. For example, images captured while the robot 102 is in the illustrated position may be stored in a “Clothing 1” file in memory 120. When a human later reviews the identified features sensed by the robot 102, it may be advantageous to organize the identified features in accordance with the annotations to provide context to the human. For example, after identifying features within images captured by the “Clothing 1” section, humans may quickly review the identified features within the clothing 1 object 502 by accessing the “Clothing 1” file.

During or after execution of the local scanning route 602-A, the robot 102 may communicate the file comprising images of the “Clothing 1” object 502 (e.g., a shelf) to a server 202, wherein the server 202 may process the images to identify specific clothing types/brands within the images via the use of one or more models configured to perform the identification. The transmission is shown by arrow 1002 which may represent online (i.e., real time) transfer of sensor data to the server 202. In some embodiments, the feature identification may be performed after completion of the local scanning route 602-A, wherein the data collected during execution of the scanning route 602-A is aggregated and communicated to the server 202 as a bundle. It is advantageous to, but not limited to, process the images separate from the robot 102 because the robot 102 may comprise finite computational resources and/or the robot 102 may be preoccupied with other tasks. Alternatively, the robot 102 may process the images/data after it has completed its route 602-A as opposed to sitting idle, however the robot 102 processing the data may inhibit the speed at which the robot 102 executes consecutive scanning routes 602. Server 202, upon processing the images to detect features using, e.g., one or more trained neural networks 300, may communicate the features detected to one or more devices 208. Such devices may comprise personal devices of one or more associates of the store/environment. The detected features may be of use for tracking inventory, detecting out of stock or misplaced items, and/or optimizing a sales floor.

The annotations 802 may provide the feature scanning process with additional context needed to identify some features. Robot 102 may localize itself during its autonomous operations, wherein the location of the robot 102 during acquisition of sensor data which represents features may be useful in determining what the features are. The location may, in part, indicate what scannable object 502 the robot 102 is sensing. For example, it should be expected that produce items are found within objects labeled as “Grocery” or similar and not within objects labeled as “Cleaning” or other unrelated objects. If the controller 118 or server 202 is unable to confidently determine what a feature is within the sensor data (i.e., a low confidence output), the controller 118 or server 202 may utilize the additional context provided by the labels 802. The controller 118 may access a subset of features associated with the “Grocery” object and bias the feature identification towards features within the subset. Additionally, the feature scanning process may bias the identification of a given feature towards features identified in the past at the same location. It is appreciated, however, that in some instances, unrelated items may appear in unrelated locations. For example, a customer may misplace an item they no longer desire, such as a box of cookies in the cleaning aisle. Accordingly, the context provided by the robot 102 location and labels 802 provide bias for the feature identification towards commonly expected features/features detected in the past at the location, and cannot be used as ground truth due to misplaced items.

Advantageously, the systems and methods disclosed herein enable a new robot 102 to be configured to scan for features within a new environment. The systems and methods disclosed herein are equally applicable to configure existing robots 102 to scan for features. Use of automatic alignment of the local scanning routes to the site map enables rapid, one-time annotation of an entire site. These annotations further enhance the feature identification process by providing useful context. The annotations additionally facilitate organized reporting of identified features by grouping identified features with their corresponding object 502 and location within the environment. Lastly, the manual and automatic edits to local scanning routes 604 herein enable a robot 102 to collect high quality sensor data of the features which further improves the feature identification process.

In some instances, the environment may change substantially, and, depending on the amount of change, appropriate actions may be performed. For example, an aisle in a store may be moved, added, or removed, thereby creating a large discrepancy between the site map, local route maps, and the real environment. These large changes may cause the alignment process to fail, thereby requiring production of a new site map. The failure to align a local scanning route to a site map, or vice versa, may be determined by the magnitude of errors (e.g., arrows 702 shown in FIG. 7B) being greater than a threshold value. If these changes to the environment cause a home marker 506 to be moved, the local scanning routes 602 beginning therefrom may be required to be retrained. Small changes to the environment (e.g., addition of a small permanent object) may be accounted for via automatic or manual route edits and may cause little to no issue in aligning local scanning maps to the site map.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least”; the term “such as” should be interpreted as “such as, without limitation”; the term ‘includes” should be interpreted as “includes but is not limited to”; the term “example” is used to provide exemplary instances of the item in discussion, not an exhaustive or limiting list thereof, and should be interpreted as “example, but without limitation”; adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where “close” may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A method for configuring a robot to scan for features within an environment, comprising:
generating a site map;
learning at least one local scanning route, wherein each of the at least one local scanning route corresponds to a local scanning route map;
aligning the at least one local scanning route to the site map;
receiving annotations of the site map, the annotations correspond to objects within the environment; and
executing any of the at least one local scanning routes while scanning for features within sensor data from sensor units of the robot.

2. The method of claim 1, further comprising:
editing at least a portion of the at least one local scanning routes based on a user input to a user interface coupled to the robot after training of the at least one local scanning routes.

3. The method of claim 1, further comprising:
transferring annotations of the site map to the objects of each of the at least one local scanning route maps based on the aligning of the at least one local scanning route maps to the site map.

4. The method of claim 1, wherein,
the annotations comprise labels for the objects to be scanned by the sensor of the robot, the objects being identified on the site map based on a user input; and
the annotations comprise at least one scanning segment associated with each of the objects, the scanning segment defines a portion of a local scanning route or area within the environment wherein the robot collects sensor data to scan for features therein.

5. The method of claim 4, further comprising:
storing the sensor data collected proximate to a scanning segment into a file, directory, or bin in memory, the file, directory or bin being associated with an annotation corresponding to the object scanned; and
storing identified features in the corresponding bin, file, or directory in memory.

6. The method of claim 1, further comprising:
communicating the sensor data to a server communicatively coupled to the robot, the server being configured to identify features within the sensor data.

7. The method of claim 1, wherein,
the sensor data comprises images.

8. The method of claim 1, wherein,
each of the at least one local scanning route maps comprise at least one object localized at least in part thereon, the at least one object is also localized, at least in part, on the site map; and
the alignment is performed by aligning each of the at least one object on the at least one local scanning route to its corresponding location on the site map.

9. The method of claim 1, wherein,
the site map is produced while the robot is moved under user guided control; and
the at least one local scanning routes are learned while under user guided control.

10. A robot, comprising:
at least one processor configured to execute computer-readable instructions from a non-transitory computer-readable memory, the instructions, when executed, cause the at least one processor to:
produce a site map;
learn at least one local scanning route, each of the at least one local scanning routes corresponds to a local scanning route map;
align the at least one local scanning route to the site map;
receive annotations of the site map, the annotations correspond to objects within the environment; and
execute any of the at least one local scanning routes while scanning for features within sensor data from sensor units.

11. The robot of claim 10, wherein the non-transitory computer-readable memory further comprises instructions which configure the at least one processor to:
edit at least a portion of the at least one local scanning routes based on a user input to a user interface coupled to the robot after training of the at least one local scanning routes.

12. The robot of claim 10, wherein the non-transitory computer-readable memory further comprises instructions which configure the at least one processor to:
transfer the annotations of the site map to the objects of each of the at least one local scanning route maps based on the aligning of the at least one local scanning route maps to the site map.

13. The robot of claim 10, wherein,
the annotations comprise labels for the objects to be scanned by the sensor of the robot, the scannable objects being identified on the site map based on a user input; and
the annotations comprise at least one scanning segment associated with each of the objects, the scanning segment defines a portion of a local scanning route or area within the environment wherein the robot collects sensor data to scan for features therein.

14. The robot of claim 13, wherein the non-transitory computer-readable memory further comprises instructions which configure the at least one processor to:
store the sensor data collected proximate to a scanning segment into a file, directory, or bin in memory, the file, directory or bin being associated with an annotation corresponding to the object scanned; and
store identified features in the corresponding bin, file, or directory in memory.

15. The robot of claim 10, wherein the non-transitory computer-readable memory further comprises instructions which configure the at least one processor to:
communicate the sensor data to a server communicatively coupled to the robot, the server being configured to identify features within the sensor data.

16. The robot of claim 10, wherein,
the sensor data comprises images.

17. The robot of claim 10, wherein,
each of the at least one local scanning route maps comprise at least one object localized at least in part thereon, the at least one object is also localized, at least in part, on the site map; and
the alignment is performed by aligning the each of the at least one object on the at least one local scanning route to its corresponding location on the site map.

18. A robot, comprising:
at least one processor configured to execute computer-readable instructions from a non-transitory computer-readable memory, the instructions, when executed, cause the at least one processor to:
produce a site map while operating under user guided control;
learn at least one local scanning route while operating under user guided control, each of the at least one local scanning routes corresponds to a local scanning route map, each local scanning route map comprises at least a portion of an object which is also localized on the site map;
edit at least a portion of the at least one local scanning routes based on a user input to a user interface coupled to the robot;
align the at least one local scanning route to the site map by aligning, for each local scanning route map, the at least portion of the object of the local scanning route map to its location on the stie map;
receive annotations of the site map, the annotations correspond to labels for objects to be scanned for features and comprise (i) identification of an object to be scanned and (ii) at least one scanning segment associated with each of the scannable objects, the scanning segment defines a portion of a local scanning route or area within the environment wherein the robot collects sensor data to scan for features therein;
transfer annotations of the site map to each of the at least one local scanning route maps based on the alignment; and
execute any of the at least one local scanning routes while scanning for features within sensor data from sensor units;
store the sensor data collected proximate to a scanning segment into a file, directory, or bin in memory, the file, directory or bin being associated with an annotation corresponding to the object scanned; and
store identified features in the corresponding bin, file, or directory in memory;
wherein, the sensor data comprises images.
